(19) United States
(12) Patent Application Publication
(10) Pub. No.: US 2026/0073868 A1
(43) Pub. Date: Mar. 12, 2026

(54) PIXEL CIRCUIT AND DISPLAY APPARATUS INCLUDING THE SAME

(71) Applicant: LG Display Co., Ltd., Seoul (KR)

(72) Inventors: Hyun Soo LEE, Paju-si (KR); Ji Yong AN, Paju-si (KR)

(73) Assignee: LG Display Co., Ltd., Seoul (KR)

(21) Appl. No.: 19/285,700

(22) Filed: Jul. 30, 2025

(30) Foreign Application Priority Data
Sep. 6, 2024 (KR) 10-2024-0121496

(51) Int. Cl. G09G 3/3233; G09G 3/3266

(52) U.S. Cl. CPC G09G 3/3233; G09G 3/3266; G09G 2300/0426; G09G 2300/0819; G09G 2300/0852; G09G 2300/0861; G09G 2310/0286; G09G 2310/08; G09G 2320/045; G09G 2330/023; G09G 2354/00

(57) ABSTRACT

Disclosed in the present disclosure is a pixel circuit. The pixel circuit according to an embodiment of the present disclosure includes a first node connected to a driving voltage line configured to receive a first constant voltage, a third node connected to a fourth node that is connected to a light-emitting element, a first driver including a first driving element, and a second driver including a second driving element. The first driver and the second driver may be alternately driven for each frame. In a pixel circuit according to the present disclosure, a threshold voltage shift phenomenon and a deterioration phenomenon of the driving element may be prevented or suppressed.

### CROSS-REFERENCE TO RELATED APPLICATION

This application claims priority to and the benefit of Korean Patent Application No. 10-2024-0121496, filed on Sep. 6, 2024, the disclosure of which is incorporated herein by reference in its entirety.

### BACKGROUND

### Field

The present disclosure relates to a pixel circuit and a display device including the same.

### Background

Electroluminescence display devices may be divided into inorganic and organic light-emitting display devices according to the material of the emission layer. An active matrix type organic light-emitting display device includes organic light-emitting diode (hereinafter referred to as “OLEDs”) that emit light by itself, and have the advantages of fast response speed, high emission efficiency, high luminance, and wide viewing angle. In an organic light-emitting display device, an organic light-emitting diode (OLED) is formed in each pixel. The organic light-emitting display device not only has fast response speed and excellent emission efficiency, luminance and viewing angle, but it also provides excellent contrast ratio and color reproduction because they may express black grayscale as true black.

A pixel circuit of an organic light-emitting display device includes an OLED and a driving element for driving the OLED. A data voltage and a reference voltage may be applied alternately to the data lines connected to the pixel circuit. In this case, the power consumption of the display device increases because the data lines are charged and discharged with the data voltage and reference voltage in one horizontal period cycle.

In such a pixel circuit where the driving element and the OLED are connected, when the pixel circuit is driven in the sampling phase and the addressing phase, the luminance of the pixels may change due to the influence of the capacitance and resistance of the OLED. If there is a deviation between the capacitance and resistance of the OLED among the pixels due to process deviations of the OLED, the luminance unevenness among the pixels may be more severe.

Furthermore, each of the plurality of pixels includes a driving element that controls the driving current flowing through the OLED based on the voltage Vgs across the gate electrode and the source electrode. The electrical characteristics of the driving element may deteriorate over time and may vary from pixel to pixel.

### SUMMARY

The present disclosure is directed to addressing the foregoing needs and/or solving the problems encountered in the related art.

Objectives according to embodiments of the present disclosure are not limited to the above-described objectives, and other objectives that are not described herein will be apparently understood by those skilled in the art from the following description.

A pixel circuit according to an example embodiment of the present disclosure comprises a first node connected to a driving voltage line configured to receive a first constant voltage, a third node connected to a fourth node that is connected to a light-emitting element, a first driver including a first driving element, and a second driver including a second driving element. The first driver and the second driver may be alternately driven for each frame.

According to various example embodiments of the present disclosure, the second driver is turned off in the (N)th frame, the first driver is turned off in the (N+1)th frame, where N is a natural number greater than or equal to 1, the (N)th frame may include an interval in which the first driving element is turned on, and the (N+1)th frame may include an interval in which the second driving element is turned on.

According to various example embodiments of the present disclosure, the first driving element may include a gate electrode connected to the second-first node, a first electrode connected to the first node, a second electrode connected to the third node, and the second driving element may include a gate electrode connected to the second-second node, a first electrode connected to the first node, a second electrode connected to the third node.

According to various example embodiments of the present disclosure, the first driver may further include a first-first switch element configured to include a gate electrode connected to a first-first gate line to which a first-first scan pulse is applied, a first electrode connected to a data line to which a data voltage is applied, and a second electrode connected to the second-first node, and the second driver may further include a first-second switch element configured to include a gate electrode connected to a first-second gate line to which a first-second scan pulse is applied, a first electrode connected to the data line, and a second electrode connected to the second-second node.

According to various example embodiments of the present disclosure, the second driver is turned off in the (N)th frame, the first driver is turned off in the (N+1)th frame, where N is a natural number greater than or equal to 1, the (N)th frame may include an interval in which the first-first switch element is turned on, and the (N+1)th frame may include an interval in which the first-second switch element is turned on.

According to various example embodiments of the present disclosure, the first driver may further include a second-first switch element configured to include a gate electrode connected to a second-first gate line to which a second-first scan pulse is applied, a first electrode connected to a reference voltage line to which a second constant voltage is applied, and a second electrode connected to the second-first node, and the second driver may further include a second-second switch element configured to include a gate electrode connected to a second-second gate line to which a second-second scan pulse is applied, a first electrode connected to the reference voltage line to which the second constant voltage is applied, and a second electrode connected to the second-second node.

According to various example embodiments of the present disclosure, the second driver is turned off in the (N)th frame, the first driver is turned off in the (N+1)th frame, where N is a natural number greater than or equal to 1, the (N)th frame may include an interval in which the second-first switch element is turned on, and the (N+1)th frame may include an interval in which the second-second switch element is turned on.

According to various example embodiments of the present disclosure, the first driver may further include a first-first capacitor configured to include a first electrode connected to the second-first node and a second electrode connected to the third node, and the second driver may further include a first-second capacitor configured to include a first electrode connected to the second-second node and a second electrode connected to the third node.

According to various example embodiments of the present disclosure, the first driver may further include a first-first switch element configured to include a gate electrode connected to a first-first gate line to which a first-first scan pulse is applied, a first electrode connected to a data line to which a data voltage is applied, and a second electrode connected to the second-first node, and a second-first switch element configured to include a gate electrode connected to a second-first gate line to which a second-first scan pulse is applied, a first electrode connected to a reference voltage line to which the second constant voltage is applied, and a second electrode connected to the second-first node.

According to various example embodiments of the present disclosure, the second driver may further include a first-second switch element configured to include a gate electrode connected to a first-second gate line to which a first-second scan pulse is applied, a first electrode connected to a data line to which a data voltage is applied, and a second electrode connected to the second-second node and a second-second switch element configured to include a gate electrode connected to a second-second gate line to which a second-second scan pulse is applied, a first electrode connected to a reference voltage line to which the second constant voltage is applied, and a second electrode connected to the second-second node.

According to various example embodiments of the present disclosure, the pixel circuit may further comprise a third switch element configured to include a gate electrode connected to a third gate line to which a third scan pulse is applied, a first electrode connected to the fourth node, and a second electrode to which a third constant voltage is applied; and a fourth switch element arranged between the driving voltage line and the first node.

According to various example embodiments of the present disclosure, the fourth switch element may include a gate electrode connected to a fourth gate line to which a first EM pulse is applied, a first electrode connected to the driving voltage line, and a second electrode connected to the first node.

According to various example embodiments of the present disclosure, the pixel circuit may further comprise a fifth switch element arranged between the third node and the fourth node.

According to various example embodiments of the present disclosure, the fifth switch element may include a gate electrode connected to a fifth gate line to which a second EM pulse is applied, a first electrode connected to the third node, and a second electrode connected to the fourth node.

In another aspect, a display device according to an example embodiment of the present disclosure comprises a display panel including a plurality of data lines, a plurality of gate lines crossed with the data lines, a plurality of power lines, and a plurality of pixel circuits that are connected to the data lines, the gate lines and the power lines, a data driver configured to supply a data voltage of pixel data to the data lines, and a gate driver configured to supply a gate signal to the gate lines. The plurality of pixel circuits each include a first node connected to a driving voltage line configured to receive a first constant voltage, a third node connected to a fourth node that is connected to a light-emitting element, a first driver including a first driving element, and a second driver including a second driving element. The first driver and the second driver may be alternately driven for each frame.

According to various example embodiments of the present disclosure, the second driver is turned off in the (N)th frame, the first driver is turned off in the (N+1)th frame, where N is a natural number greater than or equal to 1, the (N)th frame may include an interval in which the first driving element is turned on, and the (N+1)th frame may include an interval in which the second driving element is turned on.

According to various example embodiments of the present disclosure, the first driving element may include a gate electrode connected to the second-first node, a first electrode connected to the first node, a second electrode connected to the third node, and the second driving element may include a gate electrode connected to the second-second node, a first electrode connected to the first node, a second electrode connected to the third node.

According to various example embodiments of the present disclosure, the first driver may further include a first-first switch element configured to include a gate electrode connected to a first-first gate line to which a first-first scan pulse is applied, a first electrode connected to a data line to which a data voltage is applied, and a second electrode connected to the second-first node, and the second driver may further include a first-second switch element configured to include a gate electrode connected to a first-second gate line to which a first-second scan pulse is applied, a first electrode connected to the data line, and a second electrode connected to the second-second node.

According to various example embodiments of the present disclosure, the first driver may further include a second-first switch element configured to include a gate electrode connected to a second-first gate line to which a second-first scan pulse is applied, a first electrode connected to a reference voltage line to which a second constant voltage is applied, and a second electrode connected to the second-first node, and the second driver may further include a second-second switch element configured to include a gate electrode connected to a second-second gate line to which a second-second scan pulse is applied, a first electrode connected to the reference voltage line to which the second constant voltage is applied, and a second electrode connected to the second-second node.

According to various example embodiments of the present disclosure, the first driver may further include a first-first capacitor configured to include a first electrode connected to the second-first node and a second electrode connected to the third node, and the second driver may further include a first-second capacitor configured to include a first electrode connected to the second-second node and a second electrode connected to the third node.

According to various embodiments of the present disclosure, the load applied to the driving element may be reduced. Furthermore, a threshold voltage shift phenomenon of the pixel circuit may be reduced, and an operable period may be improved.

According to various embodiments of the present disclosure, a threshold voltage shift phenomenon and a deterioration phenomenon of the driving element may be prevented or suppressed.

According to various embodiments of the present disclosure, the life of the display device may be improved, while low-power operation may also become possible in the long term.

It is to be understood that both the foregoing general description and the following detailed description are by way of example and are intended to provide further explanation of the inventive concepts as claimed.

### BRIEF DESCRIPTION OF THE DRAWINGS

The accompanying drawings, which are included to provide a further understanding of the present disclosure and are incorporated in and constitute a part of this application, illustrate example embodiments of the present disclosure and together with the description serve to explain various principles of the disclosure.

FIG. 1 is a block diagram illustrating a display device according to an example embodiment of the present disclosure.

FIG. 2 is a plan view of a display device according to an example embodiment of the present disclosure.

FIG. 3 is a plan view illustrating a pixel according to an example embodiment of the present disclosure.

FIG. 4 is a cross-sectional view illustrating the display device according to an example embodiment of the present disclosure.

FIG. 5 is a view illustrating a gate driver according to example embodiments of the present disclosure.

FIG. 6 is a schematic illustrating an example pixel circuit.

FIG. 7 is a waveform diagram illustrating a driving method of the pixel circuit according to FIG. 6.

FIG. 8 is a view illustrating the duration of an example display.

FIG. 9 is a waveform view illustrating a timing signal synchronized with the image signal.

FIG. 10 is a view illustrating a pixel circuit according to a first example embodiment of the present disclosure.

FIG. 11 is a waveform view illustrating a method of driving the pixel circuit according to the first example embodiment of the present disclosure.

FIG. 12 is a view illustrating a current flowing in the pixel circuit according to a first example embodiment during an initialization phase of an (N)th frame.

FIG. 13 is a view illustrating a current flowing in the pixel circuit according to a example first embodiment during a sampling phase of an (N)th frame.

FIG. 14 is a view illustrating a current flowing in the pixel circuit according to a first example embodiment during an addressing phase of an (N)th frame.

FIG. 15 is a view illustrating a current flowing in the pixel circuit according to the first example embodiment during an emission phase of the (N)th frame.

FIG. 16 is a view illustrating a current flowing in a pixel circuit according to a first example embodiment during an initialization phase of an (N+1)th frame.

FIG. 17 is a view illustrating a current flowing in the pixel circuit according to a first example embodiment during a sampling phase of an (N+1)th frame.

FIG. 18 is a view illustrating a current flowing in the pixel circuit according to a first example embodiment during an addressing phase of an (N+1)th frame.

FIG. 19 is a view illustrating a current flowing in a pixel circuit according to a first example embodiment during an emission phase of an (N+1)th frame.

FIG. 20 is a view illustrating a pixel circuit according to a second example embodiment of the present disclosure.

FIG. 21 is a waveform view illustrating a method of driving the pixel circuit according to the example second embodiment of the present disclosure.

FIG. 22 is a view illustrating a pixel circuit according to a third example embodiment of the present disclosure.

FIG. 23 is a waveform view illustrating a method of driving the pixel circuit according to the third example embodiment of the present disclosure.

FIG. 24 is a view illustrating a pixel circuit according to a fourth example embodiment of the present disclosure.

FIG. 25 is a waveform view illustrating a method of driving the pixel circuit according to the fourth example embodiment of the present disclosure.

FIG. 26 is a view illustrating a pixel circuit according to a fifth example embodiment of the present disclosure.

FIG. 27 is a waveform view illustrating a method of driving the pixel circuit according to the fifth example embodiment of the present disclosure.

### DETAILED DESCRIPTION

The advantages and features of the present disclosure and methods for accomplishing the same will be more clearly understood from example embodiments described below with reference to the accompanying drawings. However, the present disclosure is not limited to the following embodiments but may be implemented in various different forms. Rather, the description of these example embodiments will make the disclosure of the present disclosure more complete and allow those skilled in the art to more completely comprehend the scope of the present disclosure. The protected scope of the present disclosure may be defined within the scope of the accompanying claims and their equivalents.

In describing the present disclosure, if a detailed description of a related known technology may unnecessarily obscure the subject matter of the present disclosure, the detailed description thereof may be be omitted.

Where a term like “include”, “have”, or “consist” is used in the present disclosure, other parts may be added unless a more limiting term like “only” is also used. In the case where the component is expressed in the singular, the singular includes the plural unless specifically stated otherwise.

Where a positional or interconnected relationship between two components is described, such as “on top of”, “above”, “below”, “next to”, “connect or couple with”, “crossing”, “intersecting”, etc., one or more other components may be interposed between them unless a more limiting term like “immediately”or “directly”is used.

Where a temporal contextual relationship is described, such as “after”, “following”, “next to” or “before”, it may not be continuous on a time scale unless a more limiting term like “immediately”or “directly”is used.

The terms “first”, “second”, and the like may be used to refer to components separately from each other, but the functions or structures of the components are not limited by ordinal numbers or component names in front of the components.

The following embodiments may be combined or associated with each other in whole or in part, and various types of interlocking and driving are technically possible. The embodiments may be implemented independently of each other or together in an interrelated relationship.

Terms (including technical and scientific terms) used in the embodiments of the present disclosure may be interpreted in meanings commonly understood by those skilled in the art to which the present disclosure pertains, unless explicitly and specifically defined otherwise. Also, commonly used terms, such as predefined terms, may be interpreted in consideration of their contextual meanings of the related technology.

In a display device according to various embodiments of the present disclosure, a pixel circuit and a gate driving circuit may include a plurality of transistors. The transistors may include an oxide TFT including an oxide semiconductor or a low temperature polysilicon (LTPS) TFT including LTPS.

A transistor is a three-electrode element including a gate, a source, and a drain. The source is an electrode that supplies carriers to the transistor. In the transistor, the carriers may start from the source. The drain is an electrode through which the carriers flow from the transistor to the outside. In the transistor, the carriers flow from the source to the drain.

In the case of an n-channel transistor, since carriers are electrons, a source voltage is lower than a drain voltage such that the electrons can flow from the source to the drain. In the n-channel transistor, a current flows from the drain to the source. In the case of a p-channel transistor, since carriers are holes, a source voltage is higher than a drain voltage such that the holes can flow from the source to the drain. In the p-channel transistor, since the holes flow from the source to the drain, a current flows from the source to the drain. It should be noted that a source and a drain of a transistor are not fixed. For example, the source and the drain may be changed according to voltages applied thereto. Accordingly, the present disclosure is not limited due to a source and a drain of a transistor. In the following description, a source and a drain of a transistor may be used interchangeably and be referred to as first and second electrodes.

The gate signal can swing between a gate-on voltage and a gate-off voltage. The transistor may turn-on in response to the gate-on voltage, while the transistor may turn-off in response to the gate-off voltage. In the case of an n-channel transistor, the gate-on voltage may be the gate high voltage (GHV), and the gate-off voltage may be the gate low voltage (VGL). For a p-channel transistor, the gate-on voltage may be a gate low voltage (VGL), and the gate-off voltage may be a gate high voltage (VGH).

Hereinafter, various example embodiments of the present disclosure will be described in detail with reference to the accompanying drawings.

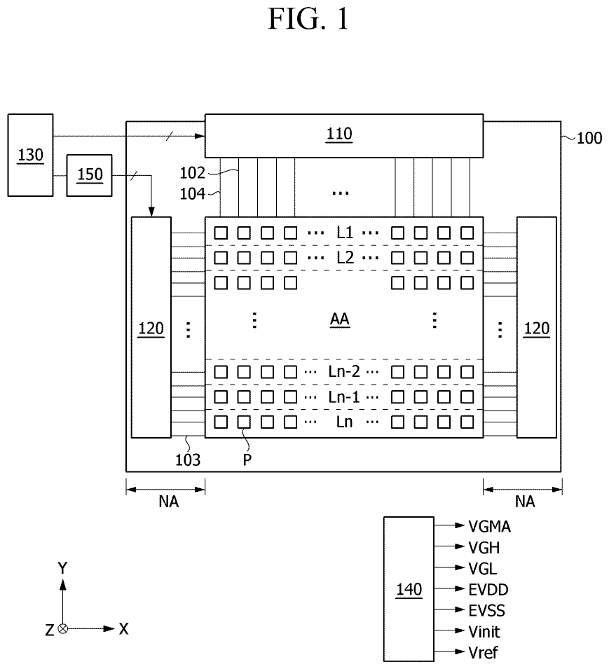

FIG. 1 is a block diagram illustrating a display device according to an embodiment of the present disclosure.

As shown in FIG. 1, a display device according to one embodiment of the present disclosure may be an organic light-emitting display device. This display device includes a display panel 100, display panel driving circuits 110 and 120 for writing image data to pixels of the display panel 100, and power circuit 140 for generating power for driving the pixels and the display panel driving circuits 110 and 120. The driving circuits 110 and 120 and the power circuit 140 may be a display panel driver that drives the display panel.

The display panel 100 may be a panel having a rectangular structure with a length in the X-axis direction, a width in the Y-axis direction, and a thickness in the Z-axis direction.

A display area AA of the display panel 100 may include a pixel array for displaying images thereon. The pixel array may include a plurality of data lines 102, a plurality of gate lines 103 intersected with the plurality of data lines 102, a plurality of sensing lines 104, and pixels P arranged in a matrix form. The display panel 100 may further include power lines commonly connected to the pixels P. The power lines may be connected to the pixels P and supply constant voltages for driving the pixels P to the pixels P.

The pixels P may be divided into two or more sub-pixels for color implementation. For example, three pixels, which are arranged sequentially along the X-axis direction, may be divided into a red sub-pixel, a green sub-pixel, and a blue sub-pixel. Further, four pixels, which are arranged sequentially along the X-axis direction, may be divided into a red sub-pixel, a green sub-pixel, a blue sub-pixel, and a white sub-pixel.

Each of the pixels P may be connected to the data line, the gate lines, and the power lines.

The pixel array may include a plurality of pixel lines L1 to Ln. Each of the pixel lines L1 to Ln may include one line of the pixels P arranged along the line direction (X-axis direction) in the pixel array of the display panel 100. The pixels arranged in one pixel line may share the gate lines 103. The pixels P arranged in a column direction (Y-axis direction) along the direction of the data lines may share the same data lines 102 and the same sensing lines 104. One horizontal period is a time obtained by dividing one frame period by the total number of the pixel lines L1 to Ln.

The display panel 100 may be implemented as a non-transmissive display panel or a transmissive display panel. The transmissive display panel may be applied to a transparent display device in which an image is displayed on a screen and an actual object in the background is visible. The display panel 100 may be implemented as a flexible display panel.

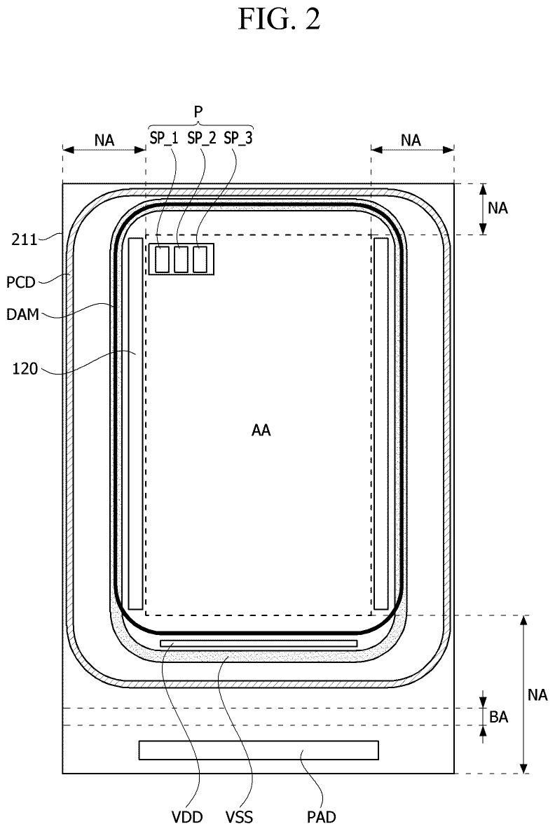

FIG. 2 is a plan view of a display device according to an embodiment of the present disclosure.

As shown in FIG. 2, a substrate 211 may include a display area AA and a non-display area NA surrounding the display area AA. The non-display area NA of the substrate 211 may be adjacent to the display area AA and may be located outwardly from the display area AA.

The display area AA may be an area in which a plurality of pixels P is arranged to display an image. A pixel P may further include a plurality of sub-pixels SP_1, SP_2, and SP_3.

The plurality of sub-pixels SP are individual units that emit light, and each of the sub-pixel SP may emit, for example, red, green, blue, or white light, but is not limited thereto.

A thin film transistor and a light-emitting device layer may be arranged in each of the sub-pixels SP_1, SP_2, and SP_3. For example, a light-emitting element for displaying an image and a circuitry for driving the light-emitting element may be arranged in the plurality of sub-pixels SP.

Each sub-pixel SP may include a plurality of thin-film transistors and a storage capacitor. For example, the sub-pixel SP may be composed of two transistors and one capacitor (2T1C), but is not limited this configuration, and may also be implemented as a sub-pixel using other configuration such as 3T1C, 4T1C, 5T1C, 6T1C, 7T1C, 3T2C, 5T2C, 6T2C, 7T2C, or 8T2C.

One pixel P may be composed of one or more sub-pixels SP that emit different colors. For example, one pixel P may include a first sub-pixel SP_1, a second sub-pixel SP_2, and a third sub-pixel SP_3.

Example shapes of the first sub-pixel SP_1, the second sub-pixel SP_2, and the third sub-pixel SP_3 may be, but are not limited to, rectangular, pentagonal, hexagonal, octagonal, circular, oval, and the like.

The first sub-pixel SP-1, the second sub-pixel SP_2, and the third sub-pixel SP_3 may emit different colors of light, and the first sub-pixel SP_1, the second sub-pixel SP_2, and the third sub-pixel SP_3 may emit at least one of red, green, or blue. The third sub-pixel SP_3 may have a larger area than the other sub-pixels. The third sub-pixel SP_3 may be arranged across other sub-pixels.

The non-display area NA may be an area in which no image is displayed, and may be an area in which various wires and driving circuits for driving a plurality of sub-pixels SP located in the display area AA are arranged. For example, various driving circuits such as gate drivers and data drivers may be arranged in the non-display area NA. The non-display area NA may be a bezel area and is not limited to terms.

The non-display area NA may be located around the display area AA. For example, the non-display area NA may be located around the display area AA. The non-display area NA may be, but is not limited to, an area in which a plurality of sub-pixels SP are not arranged.

The display area AA and the non-display area NA may be in any shape suitable for the design of the electronic device with the display panel 100 mounted thereon. If the display device is on a user-wearable device, such as a common wristwatch, it may have a circular shape, and the concepts of embodiments of the present disclosure may also apply to free-form displays, such as those found in a vehicle dashboard or the like. An example shape of the display area AA may be, but is not limited to, pentagonal, hexagonal, circular, oval, etc.

The display panel 100 of the present disclosure may include various additional elements for generating various signals or driving the plurality of sub-pixels SP_1, SP_2, and SP_3 within the display area AA. For example, one or more driving circuits for controlling the sub-pixels SP may be included in the display device. The driving circuit for controlling (or driving) the sub-pixels SP_1, SP_2, and SP_3 may include a gate driver 120, a data driver (not shown), a multiplexer (not shown), an electrostatic discharge (ESD) circuit (not shown), power wires, inverter circuit, signal wires, and the like. The power wire may be a high-potential voltage wire VDD and/or a low-potential voltage wire VSS.

The display panel 100 may also include additional elements in addition to the function for driving the sub-pixels SP_1, SP_2, and SP_3. For example, the display panel 100 may include additional elements that provide a touch sensing function, a user authentication function (e.g., fingerprint recognition), a multi-level pressure sensing function, a tactile feedback function, and the like. The aforementioned additional elements may be located in the non-display area NA or in an external circuit connected through a connection interface.

A pad part PAD may be located at one side of the non-display area NA. The pad part PAD may be a metal pattern to which external modules, such as flexible printed circuit boards (FPCB) and chip on films (COF), are bonded. While the pad part PAD is shown to be located at one side of the substrate 211, the shape and location of the pad part is not limited thereto.

The gate driver 120 for providing the gate signal to the thin film transistor may be arranged on the other side of the non-display area NA. The gate driver 120 may include various gate driving circuits, and the gate driving circuits may be formed directly on the substrate 211. In this case, the gate driver 120 may be a gate-in-panel (GIP) type.

The gate driver 120 may be located between the display area AA and the dam DAM arranged in the non-display area NA of the substrate 211.

The gate driver 120 may include a scan driving circuit, a light-emission driving circuit, and a signal wires.

The signal wire may transmit and control the signal supplied from the pad part to the scan driving circuit or the light-emission driving circuit. For example, the signal wire may be a clock wire.

The data driver that provides a data signal to the thin film transistor may be arranged on the other side of the non-display area NA. The data driver may include a variety of data driving circuits.

The high-potential voltage wire VDD, the low-potential voltage wire VSS, a multiplexer, an antistatic circuitry, and a plurality of connection wire parts may be arranged between the display area AA and the data driver. These components may be arranged between the display area AA and a bending area BA.

A connection wire part may be located in the non-display area NA. For example, the connection wire part may be located in the bending area BA, in which the substrate is bent, in the non-display area NA. The connection wire part may be configured to deliver signals (voltage) from an external module bonded to the pad part to the display area AA or to the circuitry such as the gate driver 120 and the data driver. For example, various signals, such as the data signal, the high potential voltages, and the low potential voltage, for driving the gate driver 120 may be delivered through the connection wire part.

The dam DAM may be located in the non-display area NA to surround the entirety or a portion of the display area AA. The dam DAM may be adjacent to the display area AA and may be located outside of the display area AA.

The dam DAM may be located along the periphery of the display area AA to control the flow of a layer containing organic material among the encapsulation layer arranged on the light-emitting element layer. The dam DAM may be multiple. The dam DAM may be arranged between the display area AA and the high-potential voltage wire VDD, the low-potential voltage wire VSS, the multiplexer, or the antistatic circuitry.

A panel crack detector PCD may further arranged in a portion of the non-display area NA of the substrate 211. The panel crack detector PCD may be arranged between an end point (or an end) of the substrate 211 and the dam DAM. Alternatively, the panel crack detector PCD is located downstream of the dam DAM and may at least partially overlap with the dam DAM.

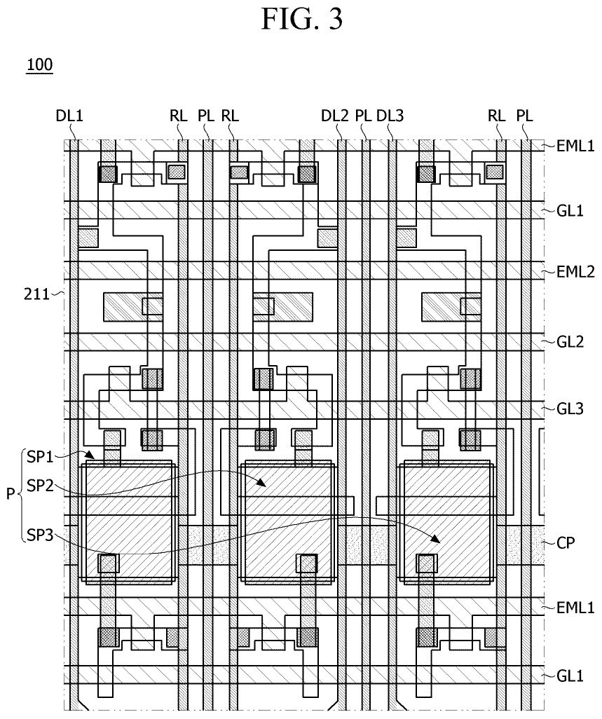

FIG. 3 is a plan view illustrating a pixel according to an embodiment of the present disclosure.

As shown in FIG. 3, the display panel 100 of the present disclosure may include three sub-pixels SP1, SP2, and SP3 that are consecutive in one direction (left-to-right direction) to form a single pixel P. Within each pixel P, the plurality of sub-pixels SP may be arranged to be spaced apart from each other by a predetermined interval.

Within one such pixel P, first to third data wires DL1, DL2, DL3 extending in the Y-axis direction may be arranged corresponding to boundaries of the sub-pixels SP1, SP2, SP3.

At the boundaries between the sub-pixels SP1, SP2, and SP3, a power wire PL for applying a high-potential power voltage, extending in the first direction, may be arranged, respectively. At the boundaries of the sub-pixels SP1, SP2, and SP3 adjacent to the power wire PL, a reference wire RL for applying a reference voltage Vref may be arranged, respectively. In addition, at the boundaries of sub-pixels SP1, SP2, and SP3 adjacent to the power wire PL, an initialization wire for applying an initialization voltage Vinit may also be arranged, respectively.

At boundaries vertically adjacent to each of the sub-pixels SP1, SP2, SP3, gate wires GL1, GL2, GL3, GL4 extending in an X-axis direction may be arranged, the gate wires intersecting with the first to third data wires DL1, DL2, DL3, the power wire PL, and the reference wire RL. The emission control signal wires EML1, EML2, EML3 may be arranged in parallel with and spaced apart from the gate wire GL1, GL2, GL3, GL4.

As display devices with higher resolutions and greater pixel densities are being developed, spatial constraints on pixel arrangement have increased, and thus the power wire PL and the reference wire RL may be formed to be shared by a plurality of sub-pixels SP. This configuration may be referred to as a flip structure in which the power wire PL and the reference wire RL are shared between two adjacent sub-pixels SP, thereby reducing the number of signal wires supplying common signals to each sub-pixel SP and saving the area occupied by the signal wires.

Accordingly, some of the sub-pixels SP may be directly connected to the power line PL and the reference line RL, while other sub-pixels SP may not be directly connected to the power line PL and the reference line RL, but instead may be connected to each of the power line PL and the reference line RL via a separate connection pattern CP.

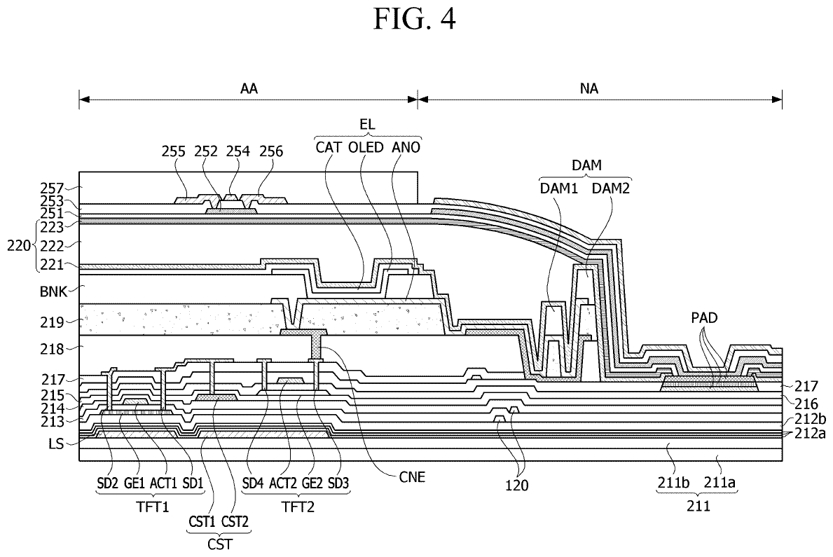

FIG. 4 is a cross-sectional view illustrating the display device according to an embodiment of the present disclosure.

As shown in FIG. 4, the display device may include two thin-film transistors TFT1 and TFT2 and one capacitor CST. The two thin-film transistors TFT1 and TFT2 may include a first thin-film transistor TFT1 including a polycrystalline semiconductor material and a second thin-film transistor TFT2 including an oxide semiconductor material.

A pixel P may include a light-emitting element EL and a pixel driving circuit that applies a driving current to the light-emitting element EL. The pixel driving circuit may be arranged on the substrate 211, and the light-emitting element EL may be arranged on the pixel driving circuit. Furthermore, an encapsulation layer 220 may be arranged on the light-emitting element EL. The encapsulation layer 220 may protect the light-emitting element EL.

The pixel driving circuit refers to a pixel P array part including a driving thin film transistor, a switching thin film transistor, and a capacitor. The light-emitting element EL refers to an array part for light emission, including an anode electrode and a cathode electrode and an emission layer arranged therebetween.

In an embodiment, the driving thin film transistor and the at least one switching thin film transistor may use an oxide semiconductor as the active layer. A thin-film transistor using an oxide semiconductor material as an active layer has an excellent leakage current blocking effect and a relatively low manufacturing cost compared to a thin-film transistor using a polycrystalline semiconductor material as an active layer. Accordingly, to reduce power consumption and lower manufacturing costs, a pixel driving circuit according to an embodiment may include a driving thin-film transistor and at least one switching thin-film transistor using an oxide semiconductor material.

All of the thin-film transistors that form the pixel driving circuit may be implemented using oxide semiconductor material, or only some of the switching thin-film transistors may be implemented using oxide semiconductor material.

However, since a thin-film transistor using an oxide semiconductor material is difficult to secure reliability, but a thin-film transistor using a polycrystalline semiconductor material has a high operating speed and excellent reliability, an embodiment may include both a switching thin-film transistor using an oxide semiconductor material and a switching thin-film transistor using a polycrystalline semiconductor material.

The substrate 211 may be implemented with a multi-layer in which an organic film and an inorganic film are alternately stacked. For example, the substrate 211 may be stacked with an organic film, such as polyimide, and an inorganic film, such as silicon oxide (SiO₂), alternating with each other.

A lower buffer layer 212a may be formed on the substrate 211. The lower buffer layer 212a may be formed by stacking a silicon oxide (SiO₂) layer or the like in multiple layers to block moisture or the like that may penetrate from the outside. An auxiliary buffer layer 212b may be further located on the lower buffer layer 212a to protect the device from moisture penetration.

A first thin film transistor TFT1 may be formed on the substrate 211. The first thin-film transistor TFT1 may utilize a polycrystalline semiconductor as the active layer. The first transistor TFT1 may include a first active layer ACT1 including a channel through which electrons or holes move, a first gate electrode GE1, a first source electrode SD1, and a first drain electrode SD2.

The first active layer ACT1 may include a first channel region, a first source region located at one side of the first channel region, and a first drain region located at the other side of the first channel region.

The first source region and the first drain region are regions obtained by doping an intrinsic polycrystalline semiconductor material to be conductive with an impurity ion of Group 5 or Group 3, for example phosphorus (P) or boron (B), at a predetermined concentration. The first channel region, in which the polycrystalline semiconductor material maintains its intrinsic state, may provide a path for the movement of electrons or holes.

On the other hand, the first thin film transistor TFT1 may include a first gate electrode GE1 overlapping the first channel region of the first active layer ACT1. A first gate insulating layer 213 may be arranged between the first gate electrode GE1 and the first active layer ACT1. The first gate insulating layer 213 may be formed by stacking an inorganic layer of silicon oxide (SiO₂), silicon nitride (SiNx), or the like in a single layer or multiple layers.

In an embodiment, the first thin-film transistor TFT1 has a top gate structure in which the first gate electrode GE1 is located on top of the first active layer ACT1. Accordingly, a first electrode CST1 included in a capacitor CST and a light shielding layer LS included in the first thin film transistor TFT1 may be formed from the same material as the first gate electrode GE1. By forming the first gate electrode GE1, the first electrode CST1, and the light shielding layer LS through a single mask process, the number of mask processes may be reduced. However, without limitation, the light shielding layer LS may be formed by a separate mask process on the lower buffer layer 212a and the auxiliary buffer layer 212b. In this case, the light shielding layer LS may be formed on the under of any transistor without being limited to the first thin-film transistor TFT1. Furthermore, the light shielding layer LS may be arranged to overlap the lower portion of the capacitor CST to form a double capacitor.

When the substrate 211 is formed of a transparent material, the light shielding layer LS may be formed under the active layers ACT1 and ACT2. The light shielding layer LS may block light passing through the transparent substrate 211 to the active layers ACT1 and ACT2 to maintain the function of the active layers ACT1 and ACT2. The light shielding layer LS may be formed on the lower buffer layer 212a, or on the auxiliary buffer layer 212b.

The first gate electrode GE1 may be formed of a metallic material. For example, the first gate electrode GE1 may be a single layer or multiple layers made of any one of, but not limited to, molybdenum (Mo), aluminum (Al), chromium (Cr), gold (Au), titanium (Ti), nickel (Ni), neodymium (Nd), and copper (Cu), or an alloy thereof.

A first interlayer insulating layer 214 may be arranged on the first gate electrode GE1. The first interlayer insulation layer 214 may be implemented with silicon oxide (SiO₂), silicon nitride (SiNx), or the like.

The display panel 100 may further include an upper buffer layer 215, a second gate insulating layer 216, and a second interlayer insulating layer 217 arranged sequentially on top of the first interlayer insulating layer 214, and a second thin-film transistor TFT2 may include a second source electrode SD3 and a second drain electrode SD4 formed on the first interlayer insulating layer 214 and connected with a second source region and a second drain region, respectively.

The first source electrode SD1 and the first drain electrode SD2 may be a single layer or a multilayer made of any one of, but is not limited to, molybdenum (Mo), aluminum (Al), chromium (Cr), gold (Au), titanium (Ti), nickel (Ni), neodymium (Nd), and copper (Cu), or an alloy thereof.

The upper buffer layer 215 may separate the second active layer ACT2 of the second thin-film transistor TFT2 implemented with the oxide semiconductor material from the first active layer ACT1 implemented with the polycrystalline semiconductor material, and provide a base for forming the second active layer ACT2.

The second gate insulating layer 216 covers the second active layer ACT2 of the second thin-film transistor TFT2. The second gate insulating layer 216 may be formed over the second active layer ACT2, which may be implemented with an oxide semiconductor material, and may therefore be implemented with an inorganic film. For example, the second gate insulating layer 216 may be silicon oxide (SiO₂), silicon nitride (SiNx), or the like.

The second gate electrode GE2 may be formed of a metallic material. For example, the second gate electrode GE2 may be a single layer or multiple layers made of any one of, but not limited to, molybdenum (Mo), aluminum (Al), chromium (Cr), gold (Au), titanium (Ti), nickel (Ni), neodymium (Nd), and copper (Cu), or an alloy thereof.

On the other hand, the second thin film transistor TFT2 may include a second active layer ACT2 formed on the upper buffer layer 215 and implemented with an oxide semiconductor material, a second gate electrode GE2 arranged on the second gate insulating layer 216, a second source electrode SD3 and a second drain electrode SD4 arranged on the second interlayer insulating layer.

The second active layer ACT2 may be implemented with an oxide semiconductor material, and may include an intrinsic second channel region that is not doped with impurities, and a second source region and a second drain region that are doped with impurities to be conductive.

The second thin-film transistor TFT2 may further include a light shielding layer LS located above the upper buffer layer 215 and overlapping the second active layer ACT2. The light shielding layer LS may block light incident on the second active layer ACT2 to ensure the reliability of the second thin-film transistor TFT2. The light shielding layer LS may be formed from the same material as the second gate electrode GE2 and may be formed on the upper surface of the first gate insulating layer 213. The light shielding layer LS may be electrically connected to the second gate electrode GE2 to form a dual gate.

The second source electrode SD3 and the second drain electrode SD4, together with the first source electrode SD1 and the first drain electrode SD2, may be simultaneously formed from the same material on the second interlayer insulating layer 217 to reduce the number of mask processes.

On the other hand, the capacitor CST may be implemented by arranging the second electrode CST2 on the first interlayer insulating layer 214 to overlap the first electrode CST1. For example, the second electrode CST2 may be a single layer or a multi-layer made of any one of, but is not limited to, molybdenum (Mo), aluminum (Al), chromium (Cr), gold (Au), titanium (Ti), nickel (Ni), neodymium (Nd), and copper (Cu), or an alloy thereof.

The capacitor CST may store the data voltage applied through the data line DL for a certain period of time and provide it to the light-emitting element EL. The capacitor CST may include two electrodes corresponding to each other and a dielectric arranged therebetween. The first interlayer insulating layer 214 may be located between the first electrode CST1 and the second electrode CST2.

The first electrode CST1 or the second electrode CST2 of the capacitor CST may be electrically connected with the second source electrode SD3 or the second drain electrode SD4 of the second thin film transistor TFT2. However, the connection relationship of the capacitors CST may change depending on the pixel driving circuit, without limitation.

On the other hand, a first planarization layer 218 and a second planarization layer 219 may be arranged sequentially on top of the pixel driving circuit to planarize the top of the pixel driving circuit. The first planarization layer 218 and the second planarization layer 219 may be organic films such as polyimide or acrylic resin. On top of the second planarization layer 219, the light-emitting element EL may be formed.

The light-emitting element EL may include an anode electrode ANO, a cathode electrode CAT, and an emission layer OLED arranged between the anode electrode ANO and the cathode electrode CAT. In a case where the pixel driving circuit connected to the cathode electrode CAT is implemented using a common low-potential voltage, the anode electrode ANO may be arranged as a separate electrode for each sub-pixel. On the other hand, in a case where the pixel driving circuit is implemented using a common high-potential voltage, the cathode electrode CAT may be arranged as a separate electrode for each sub-pixel.

The light-emitting element EL may be electrically connected to the driving element via an intermediate electrode CNE arranged on the first planarization layer 218. Specifically, the anode electrode ANO of the light-emitting element EL and the second source electrode SD3 of the second thin film transistor TFT2 that forms the pixel driving circuit may be connected to each other by the intermediate electrode CNE.

The anode electrode ANO may be connected to the intermediate electrode CNE exposed through a contact hole penetrating the second planarization layer 219. The intermediate electrode CNE may be connected to the second source electrode SD3 exposed through a contact hole penetrating the first planarization layer 218.

The intermediate electrode CNE may act as a medium between the second source electrode SD3 and the anode electrode ANO. The intermediate electrode CNE may be formed of a conductive material such as copper (Cu), silver (Ag), molybdenum (Mo), or titanium (Ti).

The anode electrode ANO may be formed as a multi-layer structure including a transparent conductive film and an opaque conductive film with high reflective efficiency. The transparent conductive film may be made of material having a relatively large work function value, such as indium-tin-oxide (ITO) or indium-zinc-oxide (IZO), and the opaque conductive films may be formed as a single layer structure or a multi-layer structure containing aluminum (Al), silver (Ag), copper (Cu), lead (Pb), molybdenum (Mo), titanium (Ti), or alloys thereof. For example, the anode electrode ANO may be formed as a structure in which a transparent conductive film, an opaque conductive film, and a transparent conductive film are sequentially stacked, or may be formed as a structure in which a transparent conductive film and an opaque conductive film are sequentially stacked.

The emission layer OLED may be formed by stacking a hole-related layer, an organic emission layer, and an electron-related layer on the anode electrode ANO in the order of or in the reverse order thereof.

A bank layer BNK may be a pixel defining film that exposes the anode electrode ANO of each pixel P. The bank layer BNK may be formed of an opaque material (e.g., black) to prevent or reduce light interference between neighboring pixels P. In this case, the bank layer BNK may include a light blocking material made of at least one of color pigment, organic black, and carbon. Additional spacers may be arranged on the bank layer BNK.

The cathode electrode CAT may face the anode electrode ANO with the emission layer OLED interposed therebetween and may be formed on the upper surface and side surface of the emission layer OLED. The cathode electrode CAT may be integrally formed across the entire display area AA. The cathode electrode CAT may be formed of a transparent conductive film, such as indium-tin-oxide (ITO) or indium-zinc-oxide (IZO), when applied to front-emitting organic light-emitting display device.

On top of the cathode electrode CAT, an encapsulation layer 220 may be further arranged to prevent or reduce moisture penetration.

The encapsulation layer 220 may prevent or suppress external moisture or oxygen from penetrating into the light-emitting element EL that is vulnerable to external moisture or oxygen. To this end, the encapsulation layer 220 may include, but is not limited to, at least one inorganic encapsulation layer and at least one organic encapsulation layer. The present disclosure will describe, by way of example, a structure of the encapsulation layer 220 in which a first encapsulation layer 221, a second encapsulation layer 222 and a third encapsulation layer 223 stacked sequentially.

The first encapsulation layer 221 may be formed on a substrate 211 on which a cathode electrode CAT is formed. A third encapsulation layer 223 may be formed on the substrate 211 on which the second encapsulation layer 222 is formed, and may be formed to surround the top surface, bottom surface, and side surfaces of the second encapsulation layer 222 together with the first encapsulation layer 221. Such first encapsulation layer 221 and third encapsulation layer 223 may suppress or prevent external moisture or oxygen from penetrating into the light-emitting element EL. The first encapsulation layer 221 and the third encapsulation layer 223 may be formed of an inorganic insulating material capable of low temperature deposition, such as silicon nitride (SiNx), silicon oxide (SiOx), silicon oxynitride (SiON), or aluminum oxide (Al₂O₃). Since the first encapsulation layer 221 and the third encapsulation layer 223 are deposited in a low-temperature atmosphere, the deposition process of the first encapsulation layer 221 and the third encapsulation layer 223 may prevent or reduce damage to the light-emitting element EL, which is vulnerable to a high-temperature atmosphere.

The second encapsulation layer 222 may serve as a buffer to relieve stress between layers due to the bending of the display device, and may planarize the step difference between the layers. This second encapsulation layer 222 may be formed of, but is not limited to, a non-sensitive organic insulating material such as acrylic resin, epoxy resin, phenolic resin, polyamide resin, polyimide resin and polyethylene or silicon oxycarbon (SiOC) or a photosensitive organic insulating material such as photoacrylic, on the substrate 211 on which the first encapsulation layer 221 is formed. When the second encapsulation layer 222 is formed using an inkjet method, a dam DAM may be arranged to prevent or suppress the liquid form of the second encapsulation layer 222 from spreading into the edges of the substrate 211. The dam DAM may be arranged closer to the edge of the substrate 211 than the second encapsulation layer 222. The dam DAM may prevent or suppress the second encapsulation layer 222 from spreading into the pad area where the conductive pad is located at the outermost portion of the substrate 211.

Even though the dam DAM may be designed to prevent or suppress the spread of the second encapsulation layer 222, if the second encapsulation layer 222 is formed to exceed the height of the dam DAM during the process, the second encapsulation layer 222, which is an organic layer, may be exposed to the outside, thereby facilitating the penetration of moisture, etc., into the light-emitting element. Therefore, to prevent or suppress this, the DAM may be formed in at least 10 or more overlapping layers. For example, the dam DAM may include a first dam DAM1 and a second dam DAM2.

The dam DAM may be arranged on the second interlayer insulating layer 217 of the non-display area NA.

Additionally, the dam DAM may be formed simultaneously with the first planarization layer 218 and the second planarization layer 219. The dam DAM may be stacked in a double structure, such that the lower layer of the dam DAM is formed together when the first planarization layer 218 is formed, and the upper layer of the dam DAM is formed together when the second planarization layer 219 is formed.

Thus, the dam DAM may be formed of, but is not limited to, the same material as the first planarization layer 218 and the second planarization layer 219.

The dam DAM may be formed to overlap low-potential voltage wire. For example, in the non-display area NA, low-potential voltage wire may be formed in the lower layer of the area where the dam DAM is located.

The low-potential voltage wire and the gate driver in the form of a Gate-In-Panel (GIP) are formed to surround the periphery of the display panel, and the low-potential voltage wire may be located further outside than the gate driver. Further, the low-potential voltage wire may be connected to the cathode electrode CAT to apply a common voltage. The gate driver is simplified in the plan and cross-sectional views, but may be formed using thin-film transistors of the same structure as the thin-film transistors in the display area AA.

The low-potential voltage wire may be arranged outside the gate driver. The low-potential voltage wire may be arranged outside the gate driver and may surround the display area AA. For example, the low-potential voltage wire may be made of the same material as the first gate electrode GE1, but not limited thereto, and may be made of the same material as the second electrode CST2 or the first source and drain electrodes SD1 and SD2, but not limited thereto.

Further, the low-potential voltage wire may be electrically connected to the cathode electrode CAT. The low-potential voltage wire may supply a low-potential driving voltage ELVSS to the plurality of pixels P of the display area AA.

On top of the encapsulation layer 220, a touch layer may be arranged. In the touch layer, a touch buffer film 251 may be located between the touch sensor metal including touch electrode connection lines 252 and 254 and touch electrodes 255 and 256, and the cathode electrode CAT of the light-emitting element EL.

The touch buffer film 251 may prevent or suppress chemical liquids (such as developer or etchant liquids) or moisture from the outside used in the manufacturing process of the touch sensor metal arranged on the touch buffer film 251 from penetrating into the emission layer OLED containing organic material. Accordingly, the touch buffer film 251 may prevent or suppress damage to the emission layer OLED that is vulnerable to chemical solutions or moisture.

The touch buffer film 251 may be formed of an organic insulating material that may be formed at a certain temperature (e.g., a low temperature of 100 degrees Celsius or less) and has a low dielectric constant of 1 to 3 to prevent or suppress damage to the emission layer OLED containing an organic material vulnerable to high temperatures. For example, the touch buffer film 251 may be formed of an acrylic, epoxy, or siloxan-based material. The touch buffer film 251 having a flattening performance as an organic insulating material may prevent or suppress damage to the encapsulation layer 220 and cracking of the touch sensor metal formed on the touch buffer film 251 due to bending of the organic light-emitting display device.

According to a mutual-capacitance based touch sensor structure, touch electrodes 255 and 256 are arranged on the touch buffer film 251, and the touch electrodes 255 and 256 may be arranged to cross each other.

The touch electrode connection lines 252 and 254 may electrically connect between the touch electrodes 255 and 256. The touch electrode connection lines 252 and 254 and the touch electrodes 255 and 256 may be located on different layers with a touch insulating film 253 interposed therebetween.

The touch electrode connection lines 252 and 254 may be arranged to overlap bank layer BNK, thereby preventing or suppressing a decrease in the aperture ratio.

On the other hand, the touch electrodes 255 and 256 may be electrically connected to the touch drive circuit (not shown) through the touch pad PAD to which a portion of the touch electrode connection line 252 extends through the upper and side surfaces of the encapsulation layer 220 and the upper and side portions of the dam DAM.

A portion of the touch electrode connection line 252 may receive touch driving signals from the touch driving circuit and transmit them to the touch electrodes 255 and 256, and may also transmit touch sensing signals from the touch electrodes 255 and 256 to the touch driving circuit.

A touch protection film 257 may be arranged over the touch electrodes 255 and 256. Although the touch protection film 257 is illustrated as arranged only over the touch electrodes 255 and 256, but not limited thereto, the touch protection film 257 may extend to before or after the dam DAM and may also be arranged over the touch electrode connection line 252, without limitation.

In addition, a color filter (not shown) may be further arranged on the encapsulation layer 220, and the color filter may be located on the touch layer, or may be located between the encapsulation layer 220 and the touch layer.

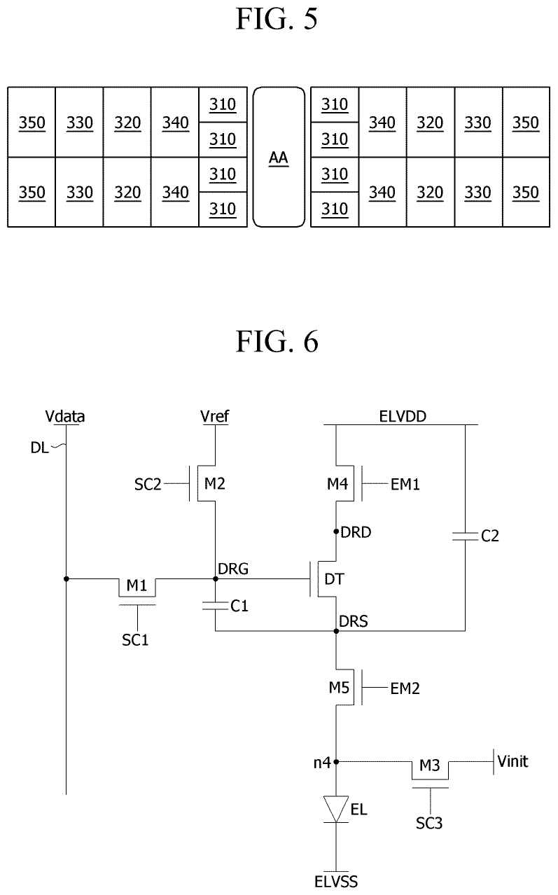

FIG. 5 is a view illustrating a gate driver according to embodiments of the present disclosure.

As shown in FIG. 5, such gate driver may include a plurality of gate drivers that output pulses of gate signals. The gate driver, according to one embodiment, may include a first gate driver 310 that outputs a first gate signal SC1, a second gate driver 320 that outputs a second gate signal SC2, a third gate driver 330 that outputs a third gate signal SC3, a fourth gate driver 340 that outputs a fourth gate signal EM1, and a fifth gate driver 350 that outputs a fifth gate signal EM2.

Some of the plurality of the gate drivers may be implemented with shift register circuits, while others may be implemented with edge trigger circuits. For example, the first gate driver 310 may be implemented with a shift register circuit, and the second gate driver 320 to the fifth gate driver 350 may be implemented with edge trigger circuits. The shift register circuit may output a gate signal to only one pixel line, and the edge trigger circuit may output a gate signal common to two or more pixel lines. Therefore, each of the first gate driver 310, which are implemented with the shift register circuits, may be connected to each of the odd-numbered pixel line and the even-numbered pixel line.

And the second gate driver 320 to the fifth gate driver 350, which are implemented with the edge trigger circuits, may be connected in common to two pixel lines.

In an embodiment, the fourth gate signal EM1 and the fifth gate signal EM2 may be emission control signals, and the first gate signal SC1, the second gate signal SC2, and the third gate signal SC3 may be scan signals.

A fifth gate driver 350 that outputs a fifth gate signals EM2, which is the emission control signal, may be arranged at the outermost portion of the gate driver. And, the second gate driver 320, which outputs the second gate signal SC2 that is a scan signal, and the third gate driver 330, which outputs the third gate signal SC3, may be arranged between the fourth gate driver 340, which outputs the fourth gate signal EM1, and the fifth gate driver 350.

A fourth gate driver 340 that outputs a fourth gate signal EM1 may be arranged between the first gate driver 310, which outputs a first gate signal SC1 that is a scan signal, and the second gate driver 320. However, this is not limited to that.

In the illustrated embodiment, the gate drivers 340 and 350 that output the emission control signals and the gate drivers 310, 320 and 330 that output the scan signals are shown as being arranged symmetrically to the left and right with respect to the display area AA, but the embodiments of the present disclosure are not limited thereto. For example, the gate drivers 340 and 350 that output the emission control signals and the gate drivers 310, 320 and 330 that output the scan signals that output the scan signal may be arranged asymmetrically to the left and right with respect to the display area AA.

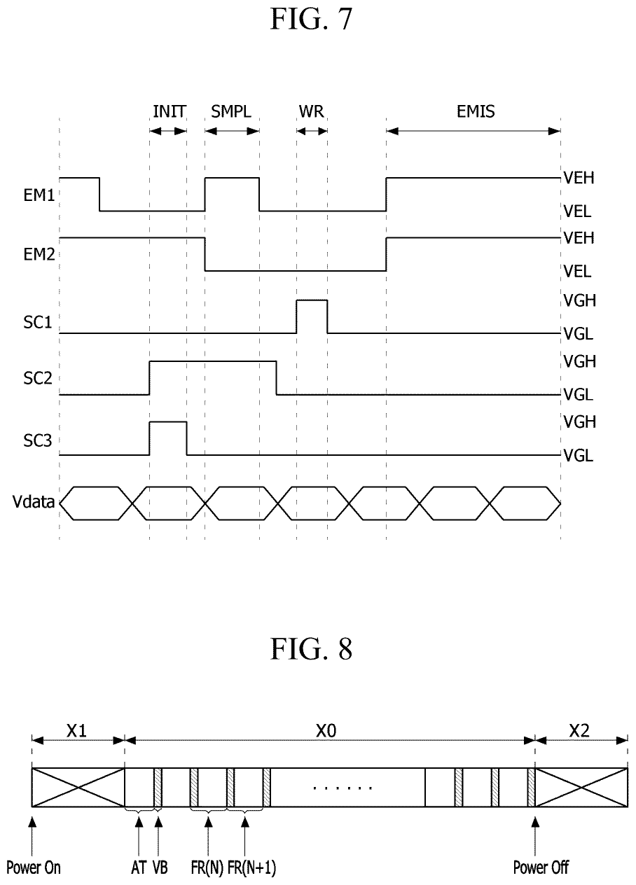

FIG. 6 is a schematic illustrating a pixel circuit. FIG. 7 is a waveform diagram illustrating a driving method of the pixel circuit according to FIG. 6.

As shown in FIGS. 6 and 7, the pixel circuit may include a light-emitting element EL, a driving element DT that supply a current to the light-emitting element EL, a plurality of switch elements M1 to M5, a first capacitor C1, and a second capacitor C2. The driving element DT and the switch elements M1, M2, M3, M4, and M5 may be implemented with n-channel transistors.

The gate signal may include a first scan pulse (or first gate pulse, SC1), a second scan pulse (or second gate pulse, SC2), a third scan pulse (or third gate pulse, SC3), a first EM pulse (or fourth gate pulse, EM1), and a second EM pulse (or fifth gate pulse, EM2).

The gate driver may include a first shift register that sequentially outputs the first scan pulse SC1, a second shift register that sequentially outputs the second scan pulse SC2, a third shift register that sequentially outputs the third scan pulse SC3, a fourth shift register that sequentially outputs the first EM pulse EM1, and a fifth shift register that sequentially outputs the second EM pulse EM2.

Constant voltages such as a pixel driving voltage ELVDD, a low-potential power voltage ELVSS, a reference voltage Vref, an initialization voltage Vinit, and the like may be applied to the pixel circuit. The pixel driving voltage ELVDD may be higher than the low-potential power voltage ELVSS.

The gate-on voltages VGH and VEH may be set to a voltage higher than the pixel driving voltage ELVDD. The gate-off voltages VGL and VEL may be set to a voltage lower than the low-potential power voltage ELVSS. However, this is not limited to that.

The initialization voltage Vinit may be set to a low-potential voltage higher than the low-potential power voltage ELVSS. The reference voltage Vref may be set to a voltage at which the driving element DT may be turned on. The reference voltage Vref may be set to a voltage within a voltage range of a data voltage Vdata output from the data driver. The maximum voltage of the data voltage Vdata may be lower than the pixel driving voltage ELVDD, and the minimum voltage of the data voltage Vdata may be higher than the low-potential power voltage ELVSS.

In order for a threshold voltage Vth of the driving element DT to be sampled during the sampling phase, the reference voltage Vref is preferably set to a voltage higher than the initialization voltage Vinit. The voltage difference between the reference voltage Vref and the initialization voltage Vinit may be set to a voltage greater than the threshold voltage Vth of the driving element DT. The initialization voltage Vinit may be set to a voltage lower than the threshold voltage of the light-emitting element EL to realize the lowest luminance of the pixel, i.e., the luminance of the black gray scale.

A driving method of the pixel circuit may include an initialization phase INIT, followed by a sampling phase SMPL, followed by an addressing phase WR, and followed by an emission phase EMIS.

The first scan pulse SC1 may be synchronized with the data voltage Vdata of the pixel data and generated as a gate-on voltage VGH during the addressing phase WR. The first scan pulse SC1 may be the gate-off voltage VGL during the initialization phase INIT, the sampling phase SMPL, and the emission phase EMIS.

The second scan pulse SC2 may be generated as the gate-on voltage VGH during the initialization phase INIT and the sampling phase SMPL. The second scan pulse SC2 may be the gate-off voltage VGL during the addressing phase WR and the emission phase EMIS.

The third scan pulse SC3 may be generated as the gate-on voltage VGH during the initialization phase INIT. The third scan pulse SC3 may be the gate-off voltage VGL during the sampling phase SMPL, the addressing phase WR, and the emission phase EMIS.

The first EM pulse EM1 may be a gate-off voltage VEL during the initialization phase INIT and the addressing phase WR. However, without limitation, the first EM pulse EM1 may be generated as the gate-on voltage VEH during the initialization phase INIT. The first EM pulse EM1 may be the gate-on voltage VEH during the sampling phase SMPL and the emission phase EMIS.

The second scan pulse EM2 may be generated as the gate-on voltage VEH during the initialization phase INIT and the emission phase EMIS. The second EM pulse EM2 may be the gate-off voltage VEL during the sampling phase SMPL and the addressing phase WR.

Each of the switch elements M1 to M5 may be turned on when the gate-on voltage VGH, VEH is applied to its gate electrode, but may be turned off when the gate-off voltage VGL, VEL is applied to its gate electrode. The driving element DT may be turned on when the gate-source voltage Vgs is higher than the threshold voltage Vth to generate a current according to the gate-source voltage Vgs to drive the light-emitting element EL.

The light-emitting element EL may be implemented with an OLED. The OLED may include an organic compound layer formed between its anode electrode and its cathode electrode. The organic compound layer may include, but is not limited to, a hole injection layer (HIL), a hole transport layer (HTL), an emission layer (EML), an electron transport layer (ETL), and an electron injection layer (EIL).

The anode electrode of the light-emitting element EL may be connected to the fourth node n4, and the cathode electrode may be connected to the ELVSS line to which the low-potential power voltage ELVSS is applied.

When a voltage is applied to the anode and cathode electrodes of the light-emitting element EL, holes that have passed through the hole transport layer (HTL) and electrons that have passed through the electron transport layer (ETL) are transported to the emission layer (EML), where excitons may be formed. In this case, light may be emitted from the EML. The light may be in the wavelength band of visible light.

The driving element DT may include a gate electrode connected to a second node DRG, a first electrode connected to a first node DRD, and a third electrode connected to a third node DRS. Thus, the voltage applied to each of the electrodes of the driving element DT may be the same as the voltage of each of the first to third nodes DRD, DRG and DRS.

The first capacitor C1 may be connected between the second node DRG and the third node DRS. The first capacitor C1 may store the gate-source voltage Vgs of the driving element DT.

The second capacitor C2 may be connected between the third node DRS and the ELVDD line. The pixel driving voltage ELVDD may be applied to the ELVDD line.

The first capacitor C1 and the second capacitor C2 may determine the transfer rate of the data voltage Vdata from the gate-source voltage Vgs of the driving element DT according to their capacitance ratio. The capacitance of the first capacitor C1 and the second capacitor C2 may be appropriately selected according to the voltage range of the data voltage Vdata and the driving characteristics of the display panel.

In the pixel circuit, the gate-source voltage Vgs of the driving element DT may be Vgs=(1−C′)×(Vdata−Vref)+Vth in the emission phase EMIS. C′ may be C1/(C1+C2). If C2=0, then C′=1, and (1−C′) is 0 (zero) in the above equation, so that Vgs=Vth may be. Therefore, the second capacitor C2 may be employed to vary the gate-source voltage Vgs of the driving element DT in accordance with the data voltage Vdata of the pixel data.

The first switch element M1 may be turned on according to the gate-on voltage VGH of the first scan pulse SC1 to supply the data voltage Vdata to the second node DRG during the addressing phase WR. The first switch element M1 may include a gate electrode connected to a first gate line to which the first scan pulse SC1 is applied, a first electrode connected to a data line DL to which the data voltage Vdata is applied, and a second electrode connected to the second node DRG.

The second switch element M2 may be turned on according to the gate-on voltage VGH of the second scan pulse SC2 to supply the reference voltage Vref to the second node DRG during the initialization phase INIT and the sampling phase SMPL. The second switch element M2 may include a gate electrode connected to a second gate line to which the second scan pulse SC2 is applied, a first electrode connected to a Vref line to which the reference voltage Vref is applied, and a second electrode connected to the second node DRG.

When the data voltage Vdata and the reference voltage Vref are applied to the pixel circuit through the data line DL, the number of transitions applied to the data line DL may increase. This may result in a higher frequency and increased power consumption of the display device.

In comparison, since the embodiment separates the data line DL, to which the data voltage Vdata is applied, and the Vref line, to which the reference voltage Vref is applied, the frequency of the voltage applied to the data line DL may be lowered, thereby reducing power consumption.

The third switch element M3 may be turned on according to the gate-on voltage VGH of the third scan pulse SC3 to apply the initialization voltage Vinit to the third node DRS during the initialization phase INIT. The third switch element M3 may include a gate electrode connected to the third gate line to which the third scan pulse SC3 is applied, a first electrode connected to the third node DRS, and a second electrode connected to the Vinit line to which the initialization voltage Vinit is applied.

The fourth switch element M4 may be turned off according to the gate-off voltage VEL of the first EM pulse EM1 to block the current path between the ELVDD line, to which the pixel driving voltage ELVDD is applied, and the first node DRD during the initialization phase INIT and the addressing phase WR. The fourth switch element M4 may be turned on according to the gate-on voltage VEH of the first EM pulse EM1 to connect the ELVDD line to the first node DRD during the sampling phase SMPL and the emission phase EMIS. The fourth switch element M4 may include a gate electrode connected to the fourth gate line to which the first EM pulse EM1 is applied, a first electrode connected to the ELVDD line, and a second electrode connected to the first node DRD.

The fifth switch element M5 may be turned off according to the gate-off voltage VEL of the second EM pulse EM2 to block the current path between the third node DRS and the fourth node n4 during the sampling phase SMPL and the addressing phase WR. The fifth switch element M5 may be turned on according to the gate-on voltage VEH of the second EM pulse EM2 to form a current path between the driving element DT and the light-emitting element EL during the initialization phase INIT and the emission phase EMIS. The fifth switch element M5 may include a gate electrode connected to a fifth gate line to which the second EM pulse EM2 is applied, a first electrode connected to a third node DRS, and a second electrode connected to a fourth node n4.

FIG. 8 is a view illustrating the duration of the display.

As shown in FIG. 8, the duration of the display device may include a first and second non-display period X1 and X2 and an image display period X0. The first non-display period X1 may be defined as an interval from power-on to the start of the first frame. The second non-display period X2 may be defined as an interval from power-off until power-on.

The image display period X0 may include an active interval AT in which data voltages are written to sub-pixels and a vertical blank interval VB in which no image data is written. The compensation period may be located outside of the active interval AT. The compensation period may be part of the first and second non-display periods X1 and X2 or the vertical blank interval VB. During the compensation period, the data driver may extract the threshold voltage of the driving transistor and, based on this, calculate the amount of change in the threshold voltage to generate the compensation data voltage. The compensation periods may include a programming period, a sensing period, a sampling period, and the like, respectively.

The active interval AT may include an (N)th frame FR(N) and an (N+1)th frame FR(N+1), where N is a natural number greater than or equal to 1. The vertical blank interval VB may be between the (N)th frame FR(N) and the (N+1)th frame FR(N+1).

The display device according to the embodiment may be adjusted based on the result that the time interval between the power activation signals generated by the power control circuit is sensed in the (N)th frame FR(N).

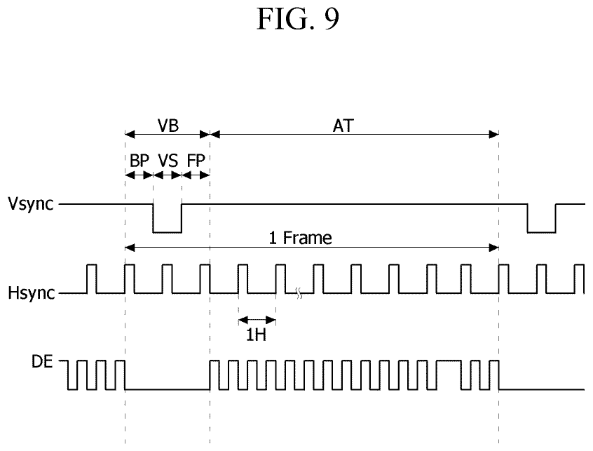

FIG. 9 is a waveform view illustrating a timing signal synchronized with the image signal.

As shown in FIG. 9, the vertical synchronization signal Vsync may define a one frame interval (1 Frame). The one Frame (1 Frame) may be the sum of the active interval AT and the vertical blank interval VB. The vertical blank interval VB may be assigned as a predetermined time between the active interval AT of the (N)th frame interval and the active interval AT of the (N+1)th frame interval. A timing controller may receive a data enable signal DE and data from the input image during the active interval AT. The data enable signal DE and data from the input image may not be present during the vertical blank interval VB. During the active interval AT, data of one frame to be written to pixels may be received by a control circuit.

The horizontal synchronization signal Hsync may define one horizontal period 1H. The data enable signal DE may be synchronized with the pixel data to be displayed on the display panel to define the valid pixel data interval. One pulse cycle of the data enable signal DE is the one horizontal period 1H, and a high logic interval of the data enable signal DE represents a pixel data input interval of 1 pixel line. One horizontal period 1H is the time period set to write data in the pixels of 1 pixel line on the display panel. The pixel line is arranged along the gate line direction and may include pixels connected to the same gate line. The pixels of 1 pixel line may share a gate line to which a gate signal (or scan signal) is applied, and may be simultaneously addressed according to the scan signal to receive a data voltage of pixel data.

As indicated by the data enable signal DE, the display device may not receive any input data during the vertical blank interval VB. The vertical blank interval VB may include a Vertical Sync time VS, a Vertical Front Porch FP, and a Vertical Back Porch BP.

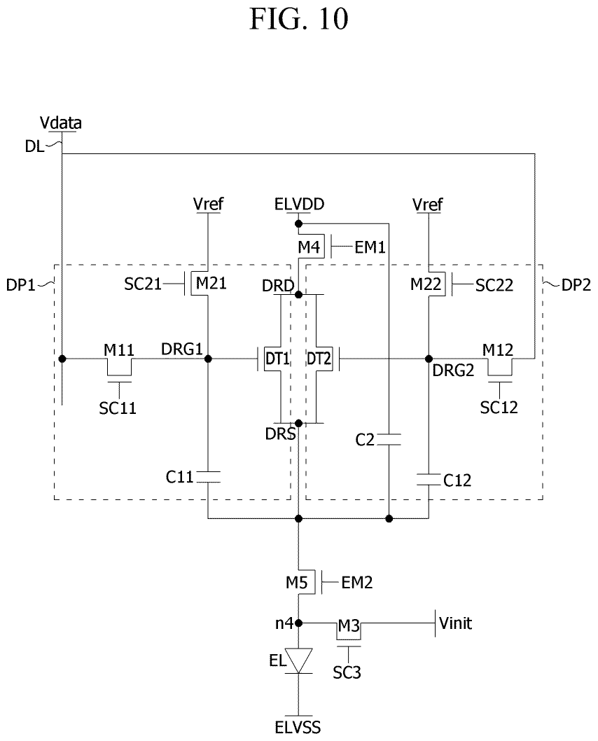

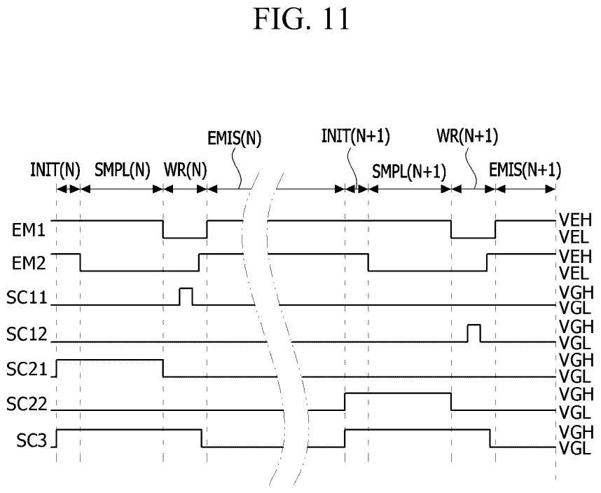

FIG. 10 is a view illustrating a pixel circuit according to a first embodiment of the present disclosure. FIG. 11 is a waveform view illustrating a method of driving the pixel circuit according to the first embodiment of the present disclosure. The same reference numerals are assigned to configurations that perform substantially the same function as the aforementioned pixel circuit, and repeated detailed descriptions are omitted.

As shown in FIGS. 10 and 11, the pixel circuit according to the embodiment of the present disclosure may include a plurality of driving elements DT1 and DT2 to prevent or suppress a threshold voltage shift phenomenon and a deterioration phenomenon of the driving elements DT over the driving time. Further, the pixel circuit may include a plurality of second nodes DRG1 and DRG2 connected to gate electrodes of each of the driving elements DT1 and DT2, first and second capacitors C11 and C12 connected to the second nodes DRG1 and DRG2, first switch elements M11 and M12, second switch elements M21 and M22, and the like.

By alternately driving each of the plurality of drivers DP1 and DP2 for each frame, the threshold voltage shift phenomenon and deterioration phenomenon that occurred by using a single driving element may be prevented or suppressed. For example, in the (N)th frame, the pixel circuit including the first driver DP1 may be driven, and in the (N+1)th frame, the pixel circuit including the second driver DP2 may be driven. As a result, a load applied to the driving element may be reduced. Furthermore, the threshold voltage shift phenomenon of the pixel circuit may be reduced, and an operable period may be improved. The lifetime of the display device may be improved, while low-power operation may also become possible in the long term.

The pixel circuit according to the embodiment of the present disclosure may include the plurality of driving elements DT1 and DT2, the first switch elements M11 and M12, the second switch elements M21 and M22, and the first and second capacitors C11 and C12.

The pixel circuit may include a first driver DP1 and a second driver DP2. The first driver DP1 may include the first driving element DT1, the first-first switch element M11, the second-first switch element M21, and the first-first capacitor C11. The second driver DP2 may include the second driving element DT2, the first-second switch element M12, the second-second switch element M22, and the first-second capacitor C12. Note that the second capacitor C2 has a first electrode connected to a ELVDD line to which a pixel driving voltage ELVDD is supplied, and a second electrode connected to a third node DRS, and may not be included in the second driver DP2.

The (N)th frame of the pixel circuit may include an (N)th initialization phase INIT(N), an (N)th sampling phase SMPL(N), an (N)th addressing phase WR(N), and an (N)th emission phase EMIS(N). The (N+1)th frame of the pixel circuit may include an (N+1)th initialization phase INIT(N+1), an (N+1)th sampling phase SMPL(N+1), an (N+1)th addressing phase WR(N+1), and an (N+1)th emission phase EMIS(N+1).

The first-first switch element M11 may be turned on according to a gate-on voltage VGH of a first-first scan pulse SC11 to supply a data voltage Vdata to a second-first node DRG1 during the (N)th addressing phase WR(N). The first-first switch element M11 may include a gate electrode connected to a first-first gate line to which the first-first scan pulse SC11 is applied, a first electrode connected to a data line DL to which the data voltage Vdata is applied, and a second electrode connected to the second-first node DRG1.

The second-first switch element M21 may be turned on according to the gate-on voltage VGH of a second-first scan pulse SC21 to supply a reference voltage Vref to the second-first node DRG1 during the (N)th initialization phase INIT(N) and the (N)th sampling phase SMPL(N). The second-first switch element M21 may include a gate electrode connected to a second-first gate line to which the second-first scan pulse SC21 is applied, a first electrode connected to a Vref line to which the reference voltage Vref is applied, and a second electrode connected to the second-first node DRG1.

The first-first capacitor C11 may include a first electrode connected to the second-first node DRG1 and a second electrode connected to the third node DRS. The first-first capacitor C11 may store a gate-source voltage Vgs of the first driving element DT1.

The first-second switch element M12 may be turned on according to a gate-on voltage VGH of a first-second scan pulse SC12 to supply the data voltage Vdata to a second-second node DRG2 during the(N+1)th addressing phase WR(N+1). The first-second switch element M12 may include a gate electrode connected to a first-second gate line to which the first-second scan pulse SC12 is applied, a first electrode connected to a data line DL to which the data voltage Vdata is applied, and a second electrode connected to the second-second node DRG2.

A second-second switch element M22 may be turned on according to a gate-on voltage VGH of a second-second scan pulse SC22 to supply the reference voltage Vref to the second-second node DRG2 during the (N+1)th initialization phase INIT(N+1) and the (N+1)th sampling phase SMPL(N+1). The second-second switch element M22 may include a gate electrode connected to a second-second gate line to which the second-second scan pulse SC22 is applied, a first electrode connected to the Vref line to which the reference voltage Vref is applied, and a second electrode connected to the second-second node DRG2.

The first-second capacitor C12 may include a first electrode connected to the second-second node DRG2 and a second electrode connected to the third node DRS. The first-second capacitor C12 may store the gate-source voltage Vgs of the second driving element DT2.

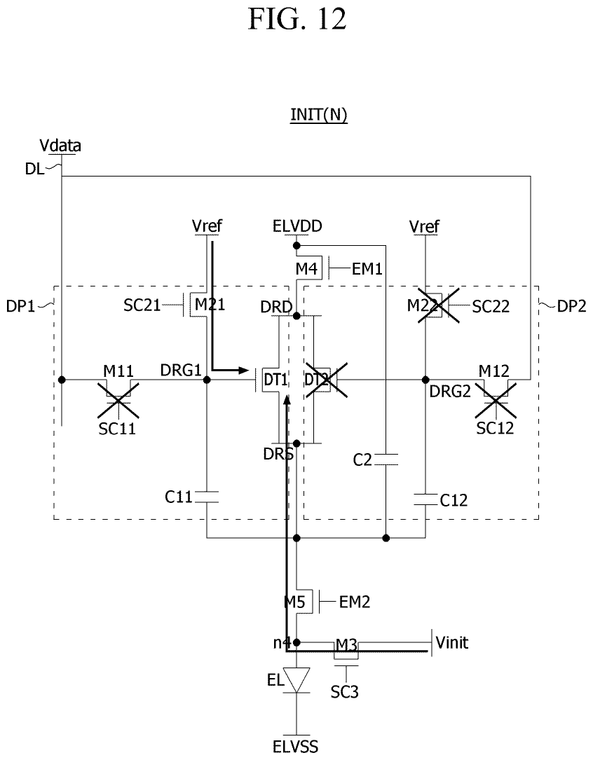

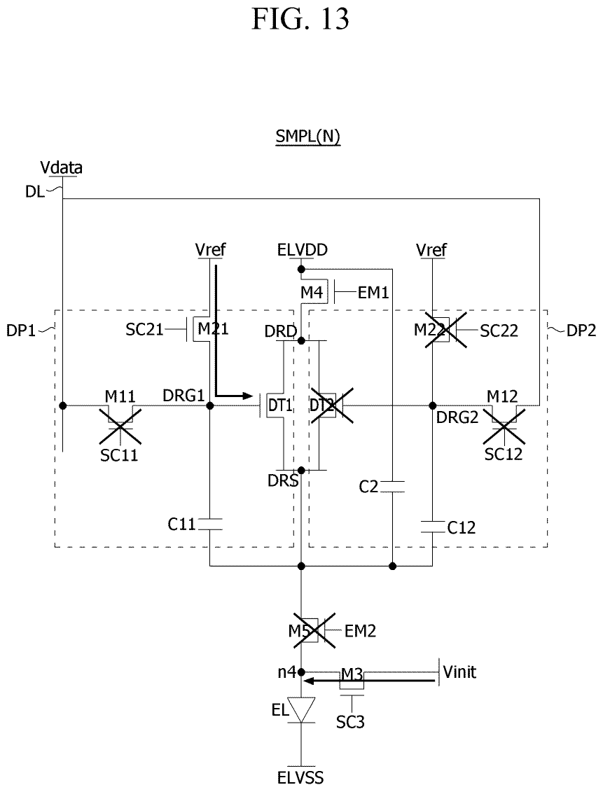

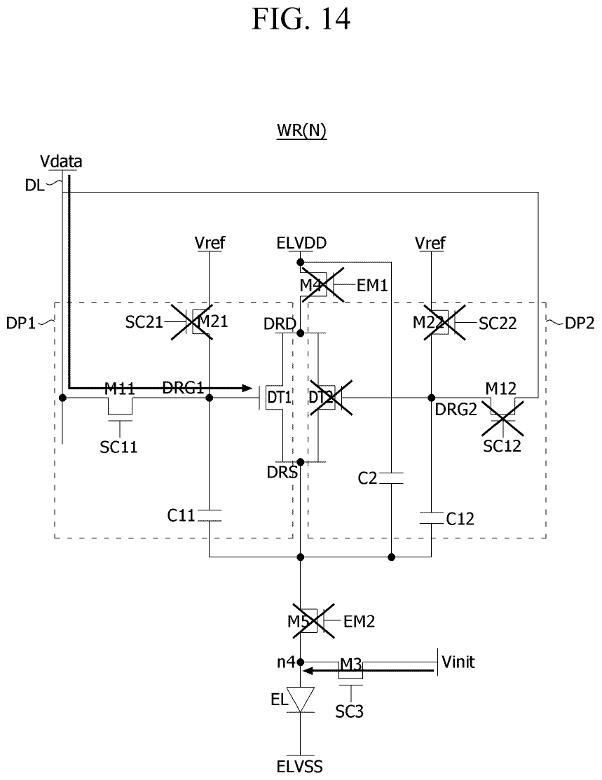

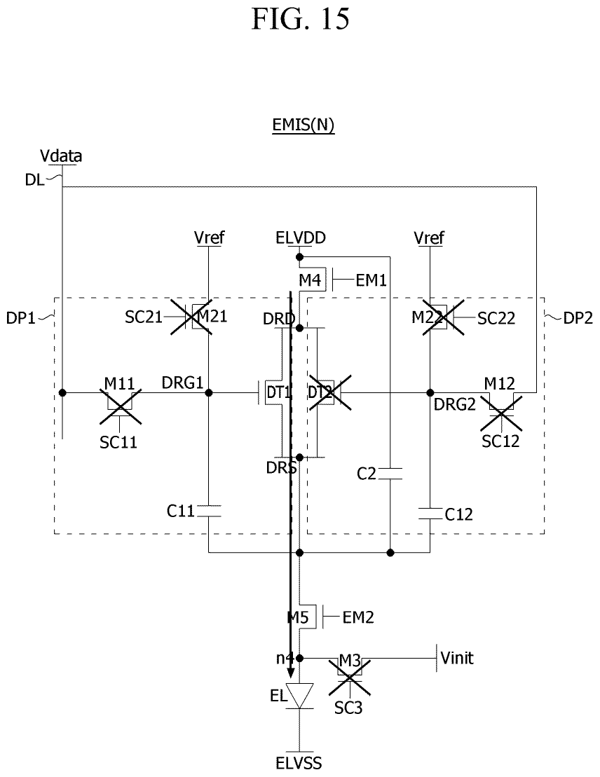

FIG. 12 is a view illustrating a current flowing in the pixel circuit according to a first embodiment during an initialization phase of an (N)th frame. FIG. 13 is a view illustrating a current flowing in the pixel circuit according to a first embodiment during a sampling phase of an (N)th frame. FIG. 14 is a view illustrating a current flowing in the pixel circuit according to a first embodiment during an addressing phase of an (N)th frame. FIG. 15 is a view illustrating a current flowing in the pixel circuit according to the first embodiment during an emission phase of the (N)th frame.

As shown in FIGS. 12 to 15, during the (N)th frame, the second driver DP2 may be turned off. For example, during the (N)th frame, the switch elements and/or driving elements included in the second driver DP2 may be turned off. For example, during the (N)th frame, the first-second and second-second switch elements M12 and M22 and the second driving element DT2 may be turned off.

As shown in FIG. 12, during the (N)th initialization phase INIT(N), the second-first, third, fourth and fifth switch elements M21, M3, M4, and M5 may be turned on. During the (N)th initialization phase INIT(N), the first-first switch element M11 may be turned off.

During the (N)th initialization phase INIT(N), the voltages of the main nodes are DRD=Vref+Vth1, DRG1=Vref, and DRS=Vinit. Here, ‘Vth1’ is the threshold voltage of the first driving element DT1. Therefore, the first driving element DT1 may be turned on because its gate-source voltage Vgs is Vref−Vinit, which is greater than the threshold voltage Vth1 during the (N)th initialization phase INIT(N).

As shown in FIG. 13, during the (N)th sampling phase SMPL(N), the second-first and fourth switch elements M21 and M4 may be turned on, while the other switch elements M11 and M5 may be turned off.

During the (N)th sampling phase SMPL(N), the first driving element DT1 may be turned off when the voltage of the third node DRS rises and the gate-source voltage Vgs of the first driving element DT1 reaches the threshold voltage Vth1. At the end of the (N)th sampling phase SMPL(N), the voltages of the main nodes are DRD=ELVDD, DRG1=Vref, and DRS=Vref−Vth1. Therefore, at the end of the (N)th sampling phase SMPL(N), the gate-source voltage Vgs of the first driving element DT1 is Vgs=Vth1. The threshold voltage Vth1 of the first driving element DT1 sampled in this way may be charged to the first-first capacitor C11.

As shown in FIG. 14, during the (N)th addressing phase WR(N), the first-first switch element M11 may be turned on and thus the data voltage Vdata of the pixel data may be applied to the second-first node DRG1. At this time, the other switch elements M21, M4, and M5 may be turned off.

At the end of the (N)th addressing phase WR(N), the voltages of the main nodes may be DRD=ELVDD, DRG1=Vdata, and DRS=Vref−Vth2+C′×(Vdata−Vref). Where, C′=C1/(C1+C2). The gate-source voltage Vgs of the first driving element DT1 may vary as Vgs=(1−C′)×(Vdata−Vref)+Vth1 during the (N)th addressing phase WR(N).

During the (N)th sampling phase SMPL(N) and the (N)th addressing phase WR(N), the third node DRS may be electrically isolated from the fourth node n4. As a result, the threshold voltage sampling and data addressing of the first driving element DT1 may not be affected by the resistance of the light-emitting element EL and the process deviation of the light-emitting element EL. Therefore, the luminance of the pixel may not be affected by the light-emitting element EL.

As shown in FIG. 15, during the (N)th emission phase EMIS(N), the fourth and fifth switch elements M4 and M5 may be turned on, while the other switch elements M11, M21 and M3 may be turned off.

During the (N)th emission phase EMIS(N), the voltages of the main nodes may vary as DRD=ELVDD, DRG1=Vdata, and DRS=Vref−Vth1+C′×(Vdata−Vref). During the (N)th emission phase EMIS(N), the voltage of the third node DRS may be equal to the anode voltage of the light-emitting element EL. The gate-source voltage Vgs of the first driving element DT1 is Vgs=(1−C′)×(Vdata−Vref)+Vth1 during the (N)th emission phase EMIS(N).

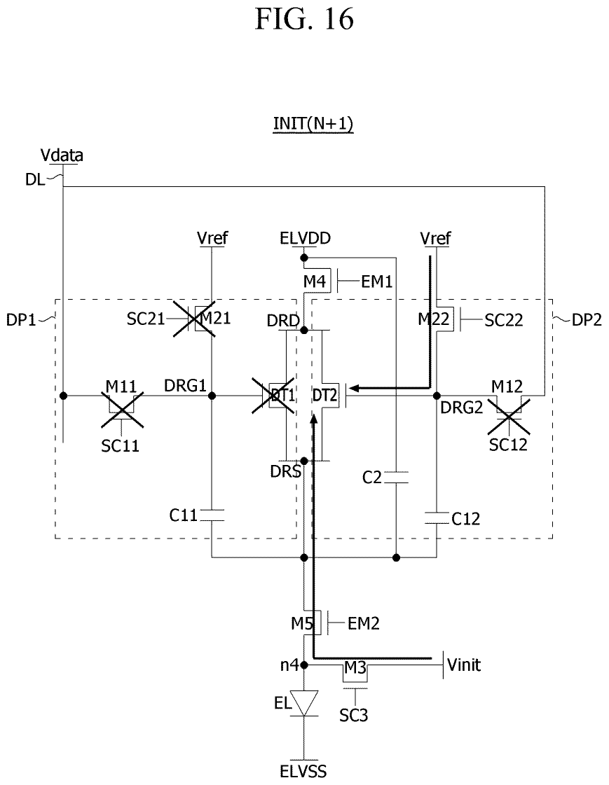

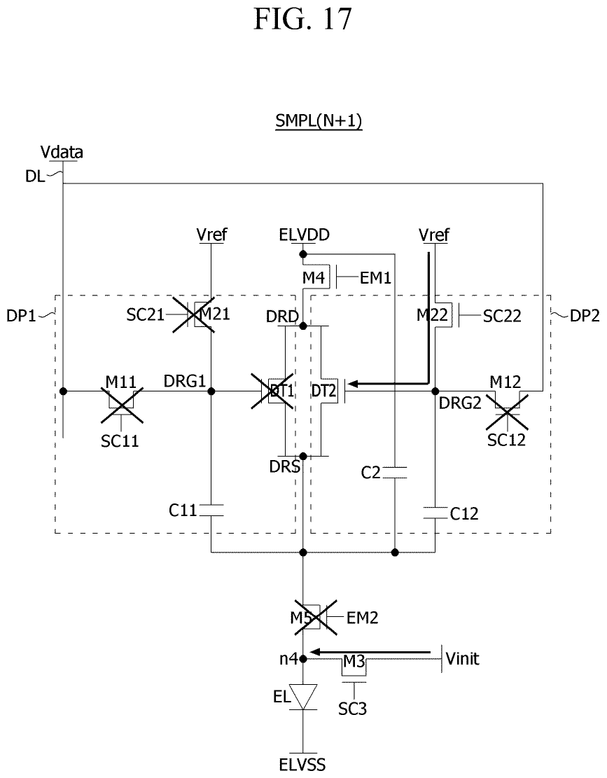

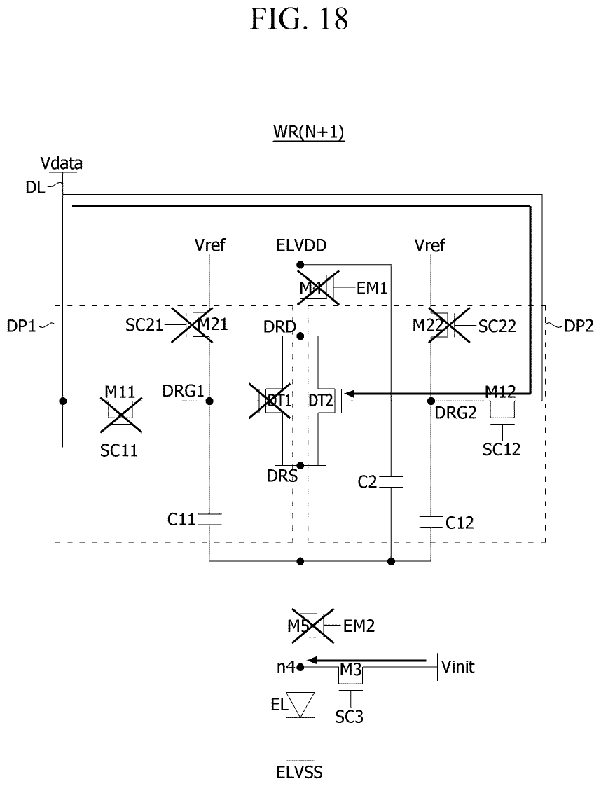

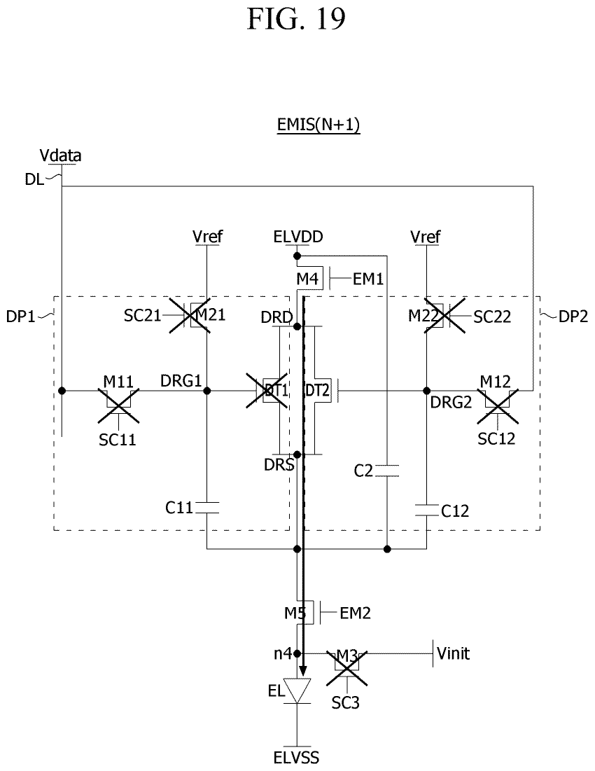

FIG. 16 is a view illustrating a current flowing in a pixel circuit according to a first embodiment during an initialization phase of an (N+1)th frame. FIG. 17 is a view illustrating a current flowing in the pixel circuit according to a first embodiment during a sampling phase of an (N+1)th frame. FIG. 18 is a view illustrating a current flowing in the pixel circuit according to a first embodiment during an addressing phase of an (N+1)th frame. FIG. 19 is a view illustrating a current flowing in a pixel circuit according to a first embodiment during an emission phase of an (N+1)th frame.

As shown in FIGS. 16 to 19, during the (N+1)th frame, the first driver DP1 may be turned off. For example, during the (N+1)th frame, the switch elements and/or driving elements included in the first driver DP1 may be turned off. For example, during the (N+1)th frame, the first-first and second-first switch elements M11 and M21 and the first driving element DT1 may be turned off.

As shown in FIG. 16, during the (N+1)th initialization phase INIT(N+1), the second-second, third, and fifth switch elements M22, M3 and M5 may be turned on. During the (N+1)th initialization phase INIT(N+1), the first-second and fourth switch elements M12 and M4 may be turned off.

During the (N+1)th initialization phase INIT(N+1), the voltages of the main nodes are DRD=Vref+Vth2, DRG2=Vref, and DRS=Vinit. Here, ‘Vth2’ is the threshold voltage of the second driving element DT2. Therefore, the second driving element DT2 may be turned on because its gate-source voltage Vgs is Vref−Vinit, which is greater than the threshold voltage Vth2 during the (N+1)th initialization phase INIT(N+1).

As shown in FIG. 17, during the (N+1)th sampling phase SMPL(N+1), the second-second and fourth switch elements M22 and M4 may be turned on, while the other switch elements M12 and M5 may be turned off.

During the (N+1)th sampling phase SMPL(N+1), the second driving element DT2 may be turned off when the voltage of the third node DRS rises and the gate-source voltage Vgs of the second driving element DT2 reaches the threshold voltage Vth2. At the end of the (N+1)th sampling phase SMPL(N+1), the voltages of the main nodes are DRD=ELVDD, DRG2=Vref, and DRS=Vref−Vth2. Therefore, at the end of the (N+1)th sampling phase SMPL(N+1), the gate-source voltage Vgs of the second driving element DT2 is Vgs=Vth2. The threshold voltage Vth2 of the second driving element DT2 sampled in this way may be charged to the first-second capacitor C12.

As shown in FIG. 18, during the (N+1)th addressing phase WR(N+1), the first-second switch element M12 may be turned on and thus the data voltage Vdata of the pixel data may be applied to the second-second node DRG2. At this time, the other switch elements M22, M4, and M5 may be turned off.

At the end of the (N+1)th addressing phase WR(N+1), the voltages of the main nodes may be DRD=ELVDD, DRG2=Vdata, and DRS=Vref−Vth2+C′×(Vdata−Vref). Where, C′=C1/(C1+C2). The gate-source voltage Vgs of the second driving element DT2 may vary as Vgs=(1−C′)×(Vdata−Vref)+Vth2 during the (N+1)th addressing phase WR(N+1).

During the (N+1)th sampling phase SMPL(N+1) and the (N+1)th addressing phase WR(N+1), the third node DRS may be electrically isolated from the fourth node n4. As a result, the threshold voltage sampling and data addressing of the second driving element DT2 may not be affected by the resistance of the light-emitting element EL and the process deviation of the light-emitting element EL. Therefore, the luminance of the pixel may not be affected by the light-emitting element EL.

As shown in FIG. 19, in the (N+1)th emission phase EMIS(N+1), the fourth and fifth switch elements M4 and M5 may be turned on, while the other switch elements M12, M22 and M3 may be turned off.

During the (N+1)th emission phase EMIS(N+1), the voltages of the main nodes may vary as DRD=ELVDD, DRG2=Vdata, and DRS=Vref−Vth2+C′×(Vdata−Vref). During the (N+1)th emission phase (EMIS(N+1)), the voltage of the third node DRS may be equal to the anode voltage of the light-emitting element EL. The gate-source voltage Vgs of the second driving element DT2 is Vgs=(1−C′)×(Vdata−Vref)+Vth2 in the (N+1)th emission phase EMIS(N+1).

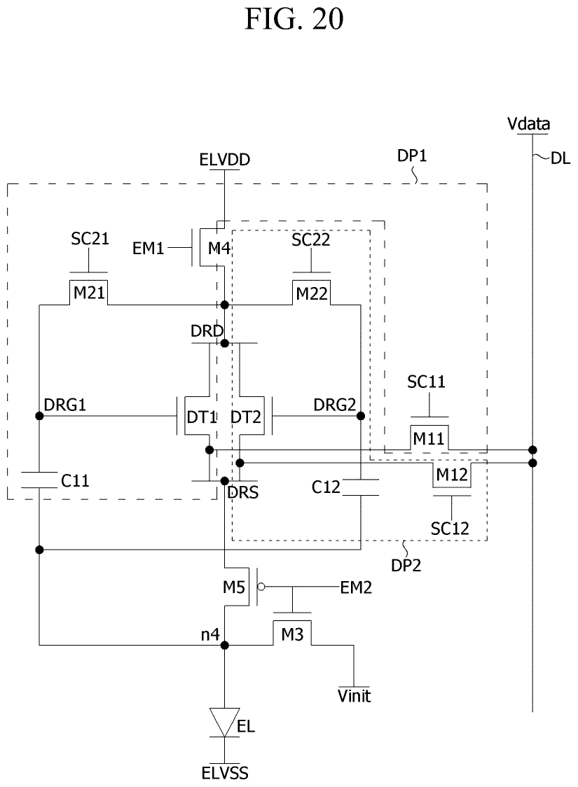

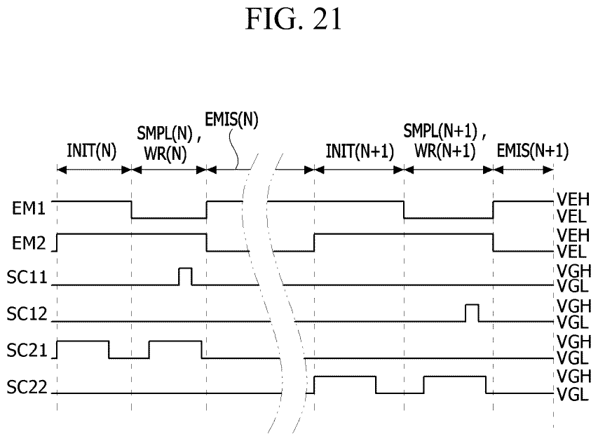

FIG. 20 is a view illustrating a pixel circuit according to a second embodiment of the present disclosure. FIG. 21 is a waveform view illustrating a method of driving the pixel circuit according to the second embodiment of the present disclosure. The same reference numerals are assigned to configurations that perform substantially the same function as the aforementioned first embodiment, and repeated detailed descriptions are omitted.

As shown in FIGS. 20 and 21, the pixel circuit may include a first driver DP1 and a second driver DP2. This embodiment may be a pixel circuit implemented in the form of a Diode Connection.

A first-first switch element M11 may be turned on according to a gate-on voltage VGH of a first-first scan pulse SC11 to supply a data voltage Vdata to a third node DRS during a (N)th sampling/addressing phase SMPL(N)/WR(N). The first-first switch element M11 may include a gate electrode connected to a first-first gate line to which the first-first scan pulse SC11 is applied, a first electrode connected to the third node DRS, and a second electrode connected to the data line DL to which the data voltage Vdata is applied.

A second-first switch element M21 may be turned on according to a gate-on voltage VGH of a second-first scan pulse SC21 to connect a gate electrode and a first electrode of a first driving element DT1 during a (N)th initialization phase INIT(N) and the (N)th sampling/addressing phase SMPL(N)/WR(N). The second-first switch element M21 may include a gate electrode connected to a second-first gate line to which a second-first scan pulse SC21 is applied, a first electrode connected to a second-first node DRG1, and a second electrode connected to a first node DRD.

A first-first capacitor C11 may be connected between the second-first node DRG1 and a fourth node n4.

A first-second switch element M12 may be turned on according to a gate-on voltage VGH of a first-second scan pulse SC12 to supply the data voltage Vdata to the third node DRS during a (N+1)th sampling/addressing phase SMPL(N+1)/WR(N+1). A first-second switch element M12 may include a gate electrode connected to a first-second gate line to which the first-second scan pulse SC12 is applied, a first electrode connected to the third node DRS, and a second electrode connected to the data line DL to which the data voltage Vdata is applied.

A second-second switch element M22 may be turned on according to a gate-on voltage VGH of a second-second scan pulse SC22 to connect a gate electrode and a first electrode of a second driving element DT2 during a (N+1)th initialization phase INIT(N+1) and the (N+1)th sampling/addressing phase SMPL(N+1)/WR(N+1). The second-second switch element M22 may include a gate electrode connected to a second-second gate line to which a second-second scan pulse SC22 is applied, a first electrode connected to a first node DRD, and a second electrode connected to a second-second node DRG2.

A first-second capacitor C12 may be connected between the second-second node DRG2 and the fourth node n4.

A second EM pulse EM2 may be generated as a gate high voltage VEH during the (N)th initialization phase INIT(N), the (N)th sampling/addressing phase SMPL(N)/WR(N), the (N+1)th initialization phase INIT(N+1) and the (N+1)th sampling/addressing phase SMPL(N+1)/WR(N+1). The second EM pulse EM2 may be generated as a gate low voltage VEL at the (N)th emission phase EMIS(N) and the (N+1)th emission phase EMIS(N+1).

In an embodiment, a fifth switch element M5 may be implemented with a p-channel transistor and a third switch element M3 may be implemented with an n-channel transistor.

When the second EM pulse EM2 is generated as the gate high voltage VEH, the fifth element M5 may be turned off and the third switch element M3 may be turned on. When the second EM pulse EM2 is generated as the gate low voltage VEL, the fifth switch element M5 may be turned on and the third switch element M3 may be turned off.

The third switch element M3 may be turned on according to the gate high voltage VEH of the second EM pulse EM2 to apply a initialization voltage Vinit to the fourth node n4 during the (N)th initialization phase INIT(N), the (N)th sampling/addressing phase SMPL(N)/WR(N), the (N+1)th initialization phase INIT(N+1) and the (N+1)th sampling/addressing phase SMPL(N+1)/WR(N+1). The third switch element M3 may include a gate electrode connected to a fifth gate line to which the second EM pulse EM2 is applied, a first electrode connected to the fourth node n4, and a second electrode connected to an Vinit line to which the initialization voltage Vinit is applied.

The fifth switch element M5 may be turned off according to the gate high voltage VEH of the second EM pulse EM2 to block a current path between the third node DRS and the fourth node n4 during the (N)th initialization phase INIT(N), the (N)th sampling/addressing phase SMPL(N)/WR(N), the (N+1)th initialization phase INIT(N+1) and the (N+1)th sampling/addressing phase SMPL(N+1)/WR(N+1). The fifth switch element M5 may be turned on according to the gate low voltage VEL of the second EM pulse EM2 to form a current path between the driving elements DT1 and DT2 and the light-emitting element EL during the (N)th emission phase EMIS(N) and the (N+1)th emission phase EMIS(N+1). The fifth switch element M5 may include a gate electrode connected to the fifth gate line to which the second EM pulse EM2 is applied, a first electrode connected to the third node DRS, and a second electrode connected to the fourth node n4.

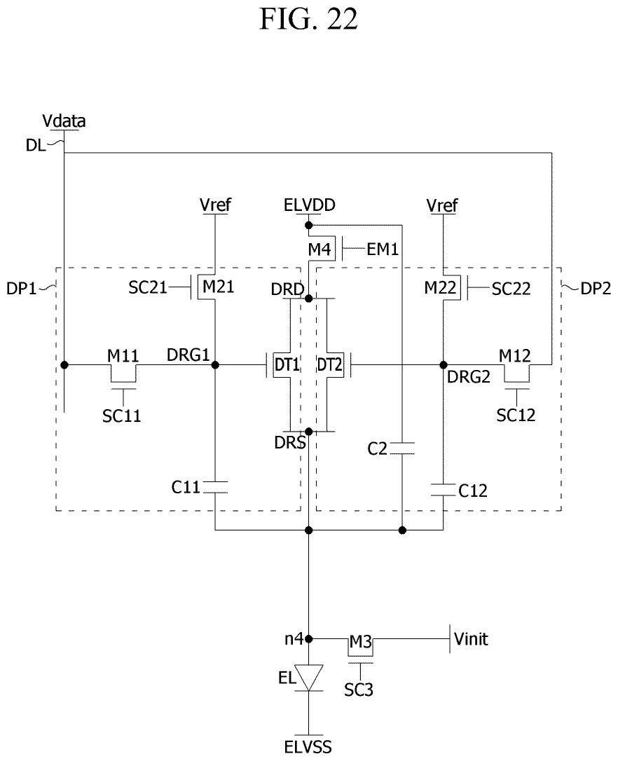

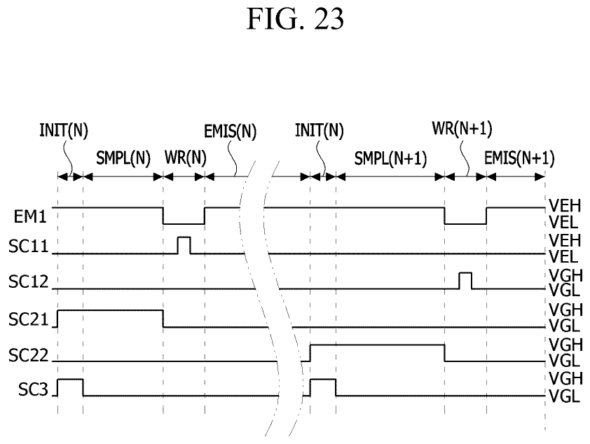

FIG. 22 is a view illustrating a pixel circuit according to a third embodiment of the present disclosure. FIG. 23 is a waveform view illustrating a method of driving the pixel circuit according to the third embodiment of the present disclosure. The same reference numerals are assigned to configurations that perform substantially the same function as the aforementioned first embodiment, and repeated detailed descriptions are omitted.

As shown in FIGS. 22 and 23, compared to the first embodiment described above, there may be no fifth switch element arranged between third node DRS and fourth node n4.

With reference to the driving method of the first embodiment described above, the third scan pulse SC3 was generated as the gate-on voltage VGH in both the sampling phase SMPL(N), SMPL(N+1) and the addressing phase WR(N), WR(N+1), but did not substantially affect the drivers DP1 and DP2 due to the presence of the fifth switch element.

This embodiment differs in that the fifth switch element is not arranged, but instead, the third scan pulse SC3 may be generated as a gate-off voltage VGL during the sampling phases SMPL(N), SMPL(N+1) and the addressing phases WR(N), WR(N+1).

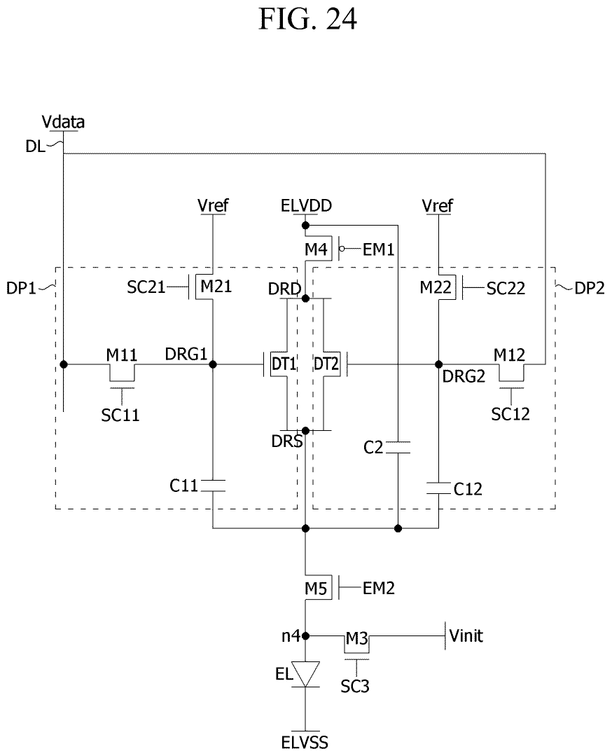

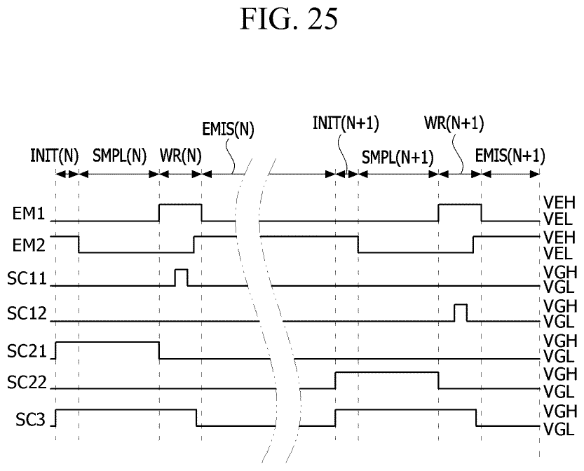

FIG. 24 is a view illustrating a pixel circuit according to a fourth embodiment of the present disclosure. FIG. 25 is a waveform view illustrating a method of driving the pixel circuit according to the fourth embodiment of the present disclosure. The same reference numerals are assigned to configurations that perform substantially the same function as the aforementioned first embodiment, and repeated detailed descriptions are omitted.

As shown in FIGS. 24 and 25, the fourth switch element M4 may be implemented with a p-channel transistor. A p-channel transistor differs in its behavior from an n-channel transistor in that a gate low voltage is a gate-on voltage and a gate high voltage is a gate-off voltage.

In one embodiment, the first EM pulse EM1 may be a gate-on voltage VEL during the initialization phase INIT(N), INIT(N+1), the sampling phase SMPL(N), SMPL(N+1), and the emission phase EMIS(N), EMIS(N+1). The first EM pulse EM1 may be a gate-off voltage VEH at the addressing phase WR(N), WR(N+1).

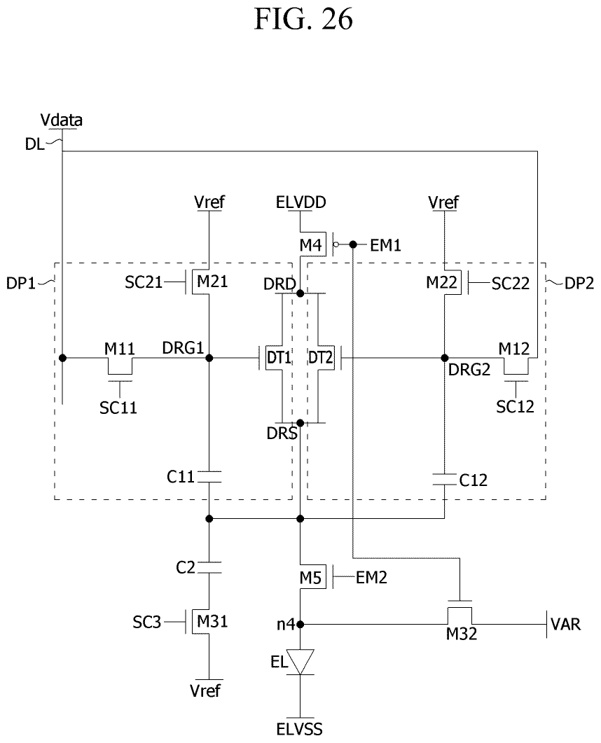

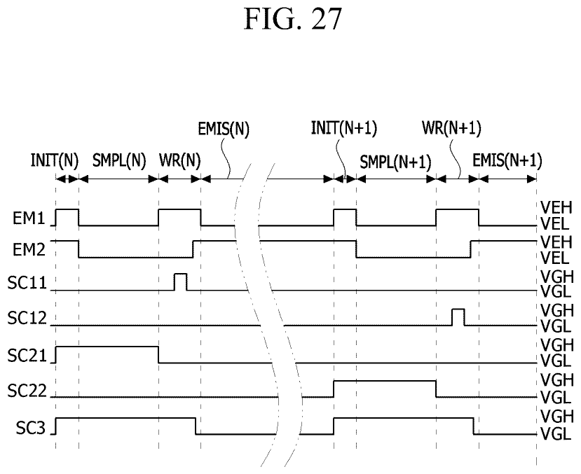

FIG. 26 is a view illustrating a pixel circuit according to a fifth embodiment of the present disclosure. FIG. 27 is a waveform view illustrating a method of driving the pixel circuit according to the fifth embodiment of the present disclosure. The same reference numerals are assigned to configurations that perform substantially the same function as the aforementioned first embodiment, and repeated detailed descriptions are omitted.

As shown in FIGS. 26 and 27, a fourth switch element M4 may be implemented with a p-channel transistor. A p-channel transistor differs in its behavior from an n-channel transistor in that a gate low voltage is a gate-on voltage and a gate high voltage is a gate-off voltage.

In one embodiment, a first EM pulse EM1 may be a gate high voltage VEH during the initialization phase INIT(N), INIT(N+1) and the addressing phase WR(N), WR(N+1). The first EM pulse EM1 may be a gate low voltage VEL during the sampling phase SMPL(N), SMPL(N+1) and the emission phase EMIS(N), EMIS(N+1).

In this embodiment, a third switch elements M31 and M32 may include a third-first switch element M31 that supplies a reference voltage Vref to a second capacitor C2 and a third-second switch element M32 that supplies an anode reset voltage VAR to a fourth node n4.

The third-first switch element M31 may include a gate electrode to which a third scan pulse SC3 is applied, a first electrode connected to the second capacitor C2, and a second electrode connected to a Vref line to which the reference voltage Vref is applied.

The third-second switch element M32 may include a gate electrode to which the first EM pulse EM1 is applied, a first electrode connected to the fourth node n4, and a second electrode connected to the VAR line to which the anode reset voltage VAR is applied.

During the initialization phase INIT(N), INIT(N+1) and the addressing phase WR(N), WR(N+1), the gate high voltage VEH may turn off the fourth switch element M4 and turn on the third-second switch element M32. When the third-second switch element M32 is turned on, the anode reset voltage VAR may be applied to a third node DRS.

During the sampling phase SMPL(N), SMPL(N+1) and the emission phase EMIS(N), EMIS(N+1), the fourth switch element M4 may be turned on and the third-second switch element M32 may be turned off by the gate low voltage VEL.

During the sampling phase SMPL(N), SMPL(N+1), the third scan pulse SC3 may be the gate-on voltage VGH, and thus the third-first switch element M31 may be turned on. The reference voltage Vref may be supplied to the third node DRS. When the voltage of the third node DRS rises and the gate-source voltage Vgs of the driving elements DT1 and DT2 reaches the threshold voltages Vth1 and Vth2, the driving elements DT1 and DT2 may be turned off. The threshold voltages Vth1 and Vth2 of the sampled driving elements DT1 and DT2 may be charged to the first and second capacitors C11 and C12.

During the emission phase EMIS(N), EMIS(N+1), the second EM pulse EM2 may be the gate-on voltage VEH, and thus the fifth switch element M5 may be turned on.

Although various example embodiments of the present disclosure have been described in more detail with reference to the accompanying drawings, the present disclosure is not necessarily limited to these embodiments, and may be variously modified without departing from the technical idea of the present disclosure.

Accordingly, the embodiments disclosed herein are not intended to limit the technical spirit of the present disclosure but merely illustrate it by way of example, and the scope of the technical idea of the present disclosure is not limited by these embodiments.

Therefore, it should be understood that the embodiments described above are illustrative in all respects and are not limited.

The scope of protection of the present disclosure should be interpreted based on the claims and their equivalents, and all technical ideas within an equivalent scope thereof should be interpreted as being included in the scope of the present disclosure.

What is claimed is:

1. A pixel circuit, comprising:
a first node connected to a driving voltage line configured to receive a first constant voltage;
a third node connected to a fourth node that is connected to a light-emitting element;
a first driver including a first driving element; and
a second driver including a second driving element,
wherein the first driver and the second driver are alternately driven for each frame.

2. The pixel circuit according to claim 1, wherein:
the second driver is configured to be turned off in an (N)th frame,
the first driver is configured to be turned off in an (N+1)th frame,
N is a natural number greater than or equal to 1,
the (N)th frame includes an interval in which the first driving element is turned on, and
the (N+1)th frame includes an interval in which the second driving element is turned on.

3. The pixel circuit according to claim 1, wherein:
the first driving element includes a gate electrode connected to a second-first node, a first electrode connected to the first node, a second electrode connected to the third node; and
the second driving element includes a gate electrode connected to a second-second node, a first electrode connected to the first node, a second electrode connected to the third node.

4. The pixel circuit according to claim 3, wherein:
the first driver further includes a first-first switch element configured to include a gate electrode connected to a first-first gate line configured to receive a first-first scan pulse, a first electrode connected to a data line configured to receive a data voltage, and a second electrode connected to the second-first node; and
the second driver further includes a first-second switch element configured to include a gate electrode connected to a first-second gate line configured to receive a first-second scan pulse, a first electrode connected to the data line, and a second electrode connected to the second-second node.

5. The pixel circuit according to claim 4, wherein:
the second driver is turned off in an (N)th frame,
the first driver is turned off in an (N+1)th frame,
N is a natural number greater than or equal to 1,
the (N)th frame includes an interval in which the first-first switch element is turned on, and
the (N+1)th frame includes an interval in which the first-second switch element is turned on.

6. The pixel circuit according to claim 3, wherein:
the first driver further includes a second-first switch element configured to include a gate electrode connected to a second-first gate line configured to receive a second-first scan pulse, a first electrode connected to a reference voltage line configured to receive a second constant voltage, and a second electrode connected to the second-first node; and
the second driver further includes a second-second switch element configured to include a gate electrode connected to a second-second gate line configured to receive a second-second scan pulse, a first electrode connected to the reference voltage line, and a second electrode connected to the second-second node.

7. The pixel circuit according to claim 6, wherein:
the second driver is turned off in an (N)th frame,
the first driver is turned off in an (N+1)th frame,
N is a natural number greater than or equal to 1,
the (N)th frame includes an interval in which the second-first switch element is turned on, and
the (N+1)th frame includes an interval in which the second-second switch element is turned on.

8. The pixel circuit according to claim 3, wherein:
the first driver further includes a first-first capacitor configured to include a first electrode connected to the second-first node and a second electrode connected to the third node; and
the second driver further includes a first-second capacitor configured to include a first electrode connected to the second-second node and a second electrode connected to the third node.

9. The pixel circuit according to claim 3, wherein the first driver further includes:
a first-first switch element configured to include a gate electrode connected to a first-first gate line configured to receive a first-first scan pulse, a first electrode connected to a data line configured to receive a data voltage, and a second electrode connected to the second-first node; and
a second-first switch element configured to include a gate electrode connected to a second-first gate line configured to receive a second-first scan pulse, a first electrode connected to a reference voltage line configured to receive a second constant voltage, and a second electrode connected to the second-first node.

10. The pixel circuit according to claim 3, wherein the second driver further includes:
a first-second switch element configured to include a gate electrode connected to a first-second gate line configured to receive a first-second scan pulse, a first electrode connected to a data line configured to receive a data voltage, and a second electrode connected to the second-second node; and
a second-second switch element configured to include a gate electrode connected to a second-second gate line configured to receive a second-second scan pulse, a first electrode connected to a reference voltage line configured to receive a second constant voltage, and a second electrode connected to the second-second node.

11. The pixel circuit according to claim 1, further comprising:
a third switch element configured to include a gate electrode connected to a third gate line configured to receive a third scan pulse, a first electrode connected to the fourth node, and a second electrode configured to receive a third constant voltage; and
a fourth switch element arranged between the driving voltage line and the first node.

12. The pixel circuit according to claim 11, wherein the fourth switch element includes:
a gate electrode connected to a fourth gate line configured to receive a first EM pulse, a first electrode connected to the driving voltage line, and a second electrode connected to the first node.

13. The pixel circuit according to claim 11, further comprising:
a fifth switch element arranged between the third node and the fourth node.

14. The pixel circuit according to claim 13, wherein the fifth switch element includes a gate electrode connected to a fifth gate line configured to receive a second EM pulse, a first electrode connected to the third node, and a second electrode connected to the fourth node.

15. A display device, comprising:
a display panel including a plurality of data lines, a plurality of gate lines intersecting with the data lines, a plurality of power lines, and a plurality of pixel circuits that are connected to the data lines, the gate lines and the power lines;
a data driver configured to supply a data voltage of pixel data to the data lines; and
a gate driver configured to supply a gate signal to the gate lines,
wherein the plurality of pixel circuits each include:
a first node connected to a driving voltage line configured to receive a first constant voltage;
a third node connected to a fourth node that is connected to a light-emitting element;
a first driver including a first driving element; and
a second driver including a second driving element, and
wherein the first driver and the second driver are alternately driven for each frame.

16. The display device according to claim 15, wherein:
the second driver is turned off in an (N)th frame,
the first driver is turned off in an (N+1)th frame,
N is a natural number greater than or equal to 1,
the (N)th frame includes an interval in which the first driving element is turned on, and
the (N+1)th frame includes an interval in which the second driving element is turned on.

17. The display device according to claim 15, wherein:
the first driving element includes a gate electrode connected to a second-first node, a first electrode connected to the first node, a second electrode connected to the third node; and
the second driving element includes a gate electrode connected to a second-second node, a first electrode connected to the first node, a second electrode connected to the third node.

18. The display device according to claim 17, wherein:
the first driver further includes a first-first switch element configured to include a gate electrode connected to a first-first gate line configured to receive a first-first scan pulse, a first electrode connected to a data line configured to receive a data voltage, and a second electrode connected to the second-first node; and
the second driver further includes a first-second switch element configured to include a gate electrode connected to a first-second gate line configured to receive a first-second scan pulse, a first electrode connected to the data line, and a second electrode connected to the second-second node.

19. The display device according to claim 17, wherein:
the first driver further includes a second-first switch element configured to include a gate electrode connected to a second-first gate line configured to receive a second-first scan pulse, a first electrode connected to a reference voltage line configured to receive a second constant voltage, and a second electrode connected to the second-first node; and
the second driver further includes a second-second switch element configured to include a gate electrode connected to a second-second gate line configured to receive a second-second scan pulse, a first electrode connected to the reference voltage line, and a second electrode connected to the second-second node.

20. The display device according to claim 17, wherein:
the first driver further includes a first-first capacitor configured to include a first electrode connected to the second-first node and a second electrode connected to the third node; and
the second driver further includes a first-second capacitor configured to include a first electrode connected to the second-second node and a second electrode connected to the third node.
